(19) United States
(12) Patent Application Publication
(10) Pub. No.: US 2026/0236243 A1
(43) Pub. Date: Aug. 13, 2026

(54) PROGRAM CONVERSION APPARATUS, PROGRAM CONVERSION METHOD, AND RECORDING MEDIUM

(71) Applicant: NEC Corporation, Tokyo (JP)

(72) Inventor: Kazuhisa ISHIZAKA, Tokyo (JP)

(73) Assignee: NEC Corporation, Tokyo (JP)

(21) Appl. No.: 19/445,778

(22) Filed: Jan. 12, 2026

(30) Foreign Application Priority Data
Feb. 10, 2025 (JP) 2025-020068

(51) Int. Cl. G06F 8/41

(52) U.S. Cl. CPC G06F 8/447

(57) ABSTRACT

After a program conversion apparatus converts a plurality of pieces of matrix data into one piece of matrix data and performs first processing of reassigning a first direction partial data identification index for identifying partial data in a first direction in the converted matrix data, second processing of deleting partial data in the first direction is performed on the one piece of matrix data obtained in the first processing, the program conversion apparatus determines an influence on processing depending on the first direction partial data identification index in a case where the execution order of the first processing and the second processing is rearranged, and generates a post-conversion program in which the execution order of the first processing and the second processing is rearranged in a case where it is determined that there is no processing depending on the first direction partial data identification index that is affected.

This application is based upon and claims the benefit of priority from Japanese patent application No. 2025-020068, filed on Feb. 10, 2025, the disclosure of which is incorporated herein in its entirety by reference.

### TECHNICAL FIELD

The present disclosure relates to a program conversion apparatus, a program conversion method, and a program.

### BACKGROUND ART

Optimization for changing an execution order of processing in a program may be performed (see, for example, JP 2004-062520 A).

### SUMMARY

It is also preferable that optimization of changing an execution order of processing can be performed for a program that handles matrix data (data in a matrix format).

An example of an object of the present disclosure is to provide a program conversion apparatus, a program conversion method, and a program that can solve the above-described problems.

According to a first aspect of the present disclosure, a program conversion apparatus includes a detection means for detecting matrix data including partial data in a second direction used for determining whether to delete individual pieces of partial data in a first direction in second processing among a plurality of pieces of matrix data, for a conversion target program for performing the second processing of deleting partial data in the first direction, with respect to one piece of matrix data obtained in first processing after performing the first processing of converting a plurality of pieces of matrix data into one piece of matrix data and reassigning a first direction partial data identification index for identifying partial data in the first direction in the converted matrix data, a determination means for determining whether both a first condition that processing depending on the first direction partial data identification index is not included in the conversion target program or that a result of processing depending on the first direction partial data identification index is same between the conversion target program and post-conversion program converted to perform the first processing after performing the second processing on the matrix data detected from the conversion target program, and a second condition that the first direction partial data identification index indicated in an execution result of the conversion target program and the first direction partial data identification index indicated in an execution result of the post-conversion program are same, are satisfied, and a conversion means for converting the conversion target program into the post-conversion program under a necessary condition that it is determined that both the first condition and the second condition are satisfied.

According to a second aspect of the present disclosure, a program conversion apparatus includes a detection means for detecting matrix data including partial data in a second direction used for determining whether to delete individual pieces of partial data in a first direction in second processing among a plurality of pieces of matrix data, with reference to a second direction partial data identification index for identifying partial data in the second direction in each of the plurality of pieces of matrix data, for a conversion target program for performing the second processing of deleting partial data in the first direction in the matrix data, with respect to one piece of matrix data obtained in first processing after performing the first processing of converting a plurality of pieces of matrix data into one piece of matrix data, and a conversion means for converting the conversion target program into a post-conversion program for performing the first processing after performing the second processing on the matrix data detected.

According to a third aspect of the present disclosure, a program conversion method includes, by a computer, detecting matrix data including partial data in a second direction used for determining whether to delete individual pieces of partial data in a first direction in second processing among a plurality of pieces of matrix data, for a conversion target program for performing the second processing of deleting partial data in the first direction, with respect to one piece of matrix data obtained in first processing after performing the first processing of converting a plurality of pieces of matrix data into one piece of matrix data and reassigning a first direction partial data identification index for identifying partial data in the first direction in the converted matrix data, determining whether both a first condition that processing depending on the first direction partial data identification index is not included in the conversion target program or that a result of processing depending on the first direction partial data identification index is same between the conversion target program and post-conversion program converted to perform the first processing after performing the second processing on the matrix data detected from the conversion target program, and a second condition that the first direction partial data identification index indicated in an execution result of the conversion target program and the first direction partial data identification index indicated in an execution result of the post-conversion program are same, are satisfied, and converting the conversion target program into the post-conversion program under a necessary condition that it is determined that both the first condition and the second condition are satisfied.

According to a fourth aspect of the present disclosure, a program causes a computer to perform detecting matrix data including partial data in a second direction used for determining whether to delete individual pieces of partial data in a first direction in second processing among a plurality of pieces of matrix data, for a conversion target program for performing the second processing of deleting partial data in the first direction, with respect to one piece of matrix data obtained in first processing after performing the first processing of converting a plurality of pieces of matrix data into one piece of matrix data and reassigning a first direction partial data identification index for identifying partial data in the first direction in the converted matrix data, determining whether both a first condition that processing depending on the first direction partial data identification index is not included in the conversion target program or that a result of processing depending on the first direction partial data identification index is same between the conversion target program and post-conversion program converted to perform the first processing after performing the second processing on the matrix data detected from the conversion target program, and a second condition that the first direction partial data identification index indicated in an execution result of the conversion target program and the first direction partial data identification index indicated in an execution result of the post-conversion program are same, are satisfied, and converting the conversion target program into the post-conversion program under a necessary condition that it is determined that both the first condition and the second condition are satisfied.

According to an aspect of the present disclosure, optimization of changing an execution order of processing can be performed for a program that handles data in a matrix format.

### BRIEF DESCRIPTION OF THE DRAWINGS

FIG. 1 is a diagram illustrating an example of a configuration of an information processing apparatus according to at least one example embodiment;

FIG. 2 is a diagram illustrating a first example of a conversion target program according to at least one example embodiment;

FIG. 3 is a diagram illustrating a first example of a post-conversion program according to at least one example embodiment;

FIG. 4 is a diagram illustrating a second example of a conversion target program according to at least one example embodiment;

FIG. 5 is a diagram illustrating an example of conversion of matrix data by the conversion target program in FIG. 4;

FIG. 6 is a diagram illustrating a second example of a post-conversion program according to at least one example embodiment;

FIG. 7 is a diagram illustrating an example of conversion of matrix data by the post-conversion program in FIG. 6;

FIG. 8 is a diagram illustrating a third example of a conversion target program according to at least one example embodiment;

FIG. 9 is a diagram illustrating an example of conversion of matrix data by the conversion target program in FIG. 8;

FIG. 10 is a diagram illustrating a third example of a post-conversion program according to at least one example embodiment;

FIG. 11 is a diagram illustrating an example of conversion of matrix data by the post-conversion program in FIG. 10;

FIG. 12 is a diagram illustrating a fourth example of a conversion target program according to at least one example embodiment;

FIG. 13 is a diagram illustrating an example of intermediate representation of data reading according to at least one example embodiment;

FIG. 14 is a diagram illustrating an example of intermediate representation other than data reading according to at least one example embodiment;

FIG. 15 is a diagram illustrating an example of intermediate representation of reading of a column name of matrix data according to at least one example embodiment;

FIG. 16 is a diagram illustrating an example of an intermediate representation in which reading of matrix data and a column name are rewritten so as to be associated with each other according to at least one example embodiment;

FIG. 17 is a diagram illustrating a first example of conversion of matrix data by a conversion target program in a case where a row name is indicated in matrix data;

FIG. 18 is a diagram illustrating a second example of conversion of matrix data by a conversion target program in a case where a row name is indicated in matrix data;

FIG. 19 is a diagram illustrating an example of an execution target program satisfying both a third condition and a fourth condition according to at least one example embodiment;

FIG. 20 is a diagram illustrating an example of a case where both the third condition and the fourth condition according to at least one example embodiment are satisfied;

FIG. 21 is a diagram illustrating a first example in a case where either the third condition or the fourth condition according to at least one example embodiment is not satisfied;

FIG. 22 is a diagram illustrating a second example in a case where either the third condition or the fourth condition according to at least one example embodiment is not satisfied;

FIG. 23 is a diagram illustrating an example of a procedure of processing in which an information processing apparatus according to at least one example embodiment optimizes an optimization target program that handles matrix data in which an index column is provided;

FIG. 24 illustrates an example of a case where an optimization unit according to at least one example embodiment repeatedly performs optimization of rearranging the execution order of the first processing and the second processing;

FIG. 25 is a diagram illustrating an example of a configuration of a program conversion apparatus according to at least one example embodiment;

FIG. 26 is a diagram illustrating an example of a configuration of a program conversion apparatus according to at least one example embodiment;

FIG. 27 is a diagram illustrating an example of a configuration of an information processing apparatus according to at least one example embodiment;

FIG. 28 is a diagram illustrating an example of a configuration of an information processing apparatus according to at least one example embodiment;

FIG. 29 is a diagram illustrating an example of processing in a program conversion method according to at least one example embodiment;

FIG. 30 is a diagram illustrating an example of processing in a program conversion method according to at least one example embodiment;

FIG. 31 is a diagram illustrating an example of processing in an information processing method according to at least one example embodiment;

FIG. 32 is a diagram illustrating an example of processing in an information processing method according to at least one example embodiment; and

FIG. 33 is a diagram illustrating an example of a configuration of a computer according to at least one example embodiment.

### EXAMPLE EMBODIMENT

Hereinafter, example embodiments will be described with reference to the drawings.

### First Example Embodiment

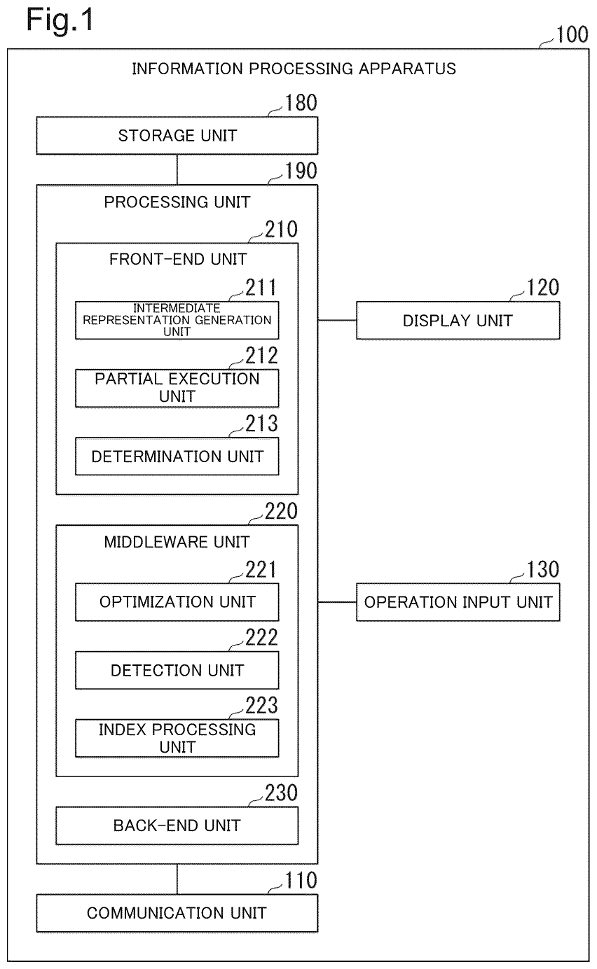

FIG. 1 is a diagram illustrating an example of a configuration of an information processing apparatus according to at least one example embodiment. In the configuration illustrated in FIG. 1, an information processing apparatus 100 includes a communication unit 110, a display unit 120, an operation input unit 130, a storage unit 180, and a processing unit 190. The processing unit 190 includes a front-end unit 210, a middleware unit 220, and a back-end unit 230. The front-end unit 210 includes an intermediate representation generation unit 211, a partial execution unit 212, and a determination unit 213.

The middleware unit 220 includes an optimization unit 221, a detection unit 222, and an index processing unit 223.

The information processing apparatus 100 executes the source program by runtime compilation. In the runtime compilation, the information processing apparatus 100 partially converts the source program into an intermediate representation (IR). Then, at the time of execution of a command that requires a value such as a variable or an operation, such as a “print” command, the information processing apparatus 100 executes intermediate representation to calculate a variable value or the like. Obtaining a value of a variable, an operation, or the like is also referred to as evaluating the variable, the operation, or the like.

The source program here is a program to be executed by the information processing apparatus 100.

Converting the source program into the intermediate representation is also referred to as generating the intermediate representation.

The intermediate representation can be regarded as a program expressed in the form of an intermediate representation.

The information processing apparatus 100 performs optimization by changing the execution order of the commands included in the intermediate representation. Changing the execution order of the commands included in the intermediate representation can be regarded as changing the execution order of the commands included in the source program.

The information processing apparatus 100 may change the execution order of the commands included in the source program instead of the intermediate representation.

The source program before being optimized or the intermediate representation before being optimized is also referred to as a conversion target program. The optimized source program or the optimized intermediate representation is also referred to as a post-conversion program.

In particular, the information processing apparatus 100 optimizes a program (source program or intermediate representation) that handles matrix data (data in a matrix format). The matrix referred to herein may be a two-dimensional array. The matrix data can also be referred to as data in a table format.

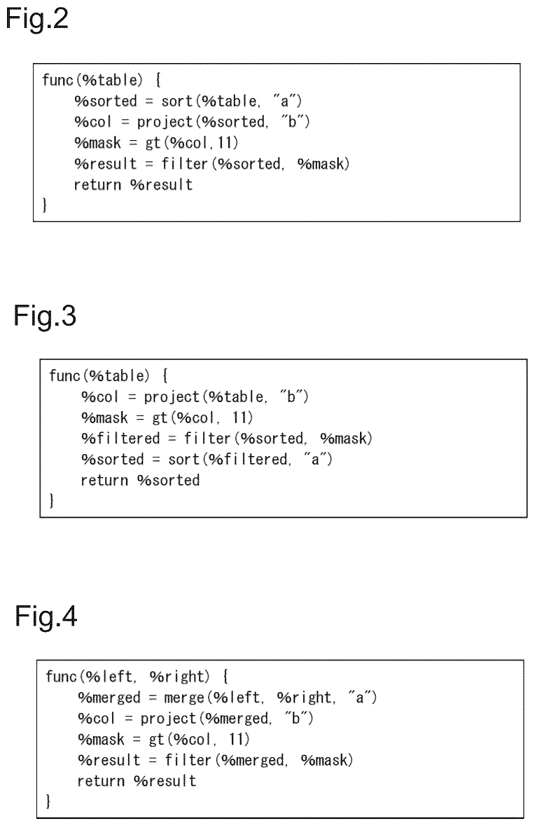

FIG. 2 is a diagram illustrating a first example of the conversion target program. FIG. 2 illustrates a first example of the intermediate representation before being optimized.

In the example of FIG. 2, “% sorted=sort(% table, “a”)” indicates that sorting is performed with the column “a” as a key on the matrix data “% table” obtained as an argument of the function “func”. “% col=project(% sorted, “b”)”, “% mask =gt(% col, 11)”, and “% result=filter(% sorted, % mask)” indicate that a row in which the element value of the “b” column is larger than 11 is extracted from the sorted matrix data “% sorted”, and the matrix data “% result” is generated.

FIG. 3 is a diagram illustrating a first example of the post-conversion program. FIG. 3 illustrates a first example of the optimized intermediate representation. Specifically, FIG. 3 illustrates an example of a post-conversion program obtained by the information processing apparatus 100 performing optimization on the conversion target program of FIG. 2.

In the example of FIG. 3, “% col=project(% table, “b”)”, “% mask=gt(% col, 11)”, and “% filtered=filter(% sorted, % mask)” indicate that a row in which the element value of the “b” column is larger than 11 is extracted from the matrix data “% table” obtained as the argument of the function “func”, and the matrix data “% filtered” is generated. “% sorted=sort(% filtered, “a”)” indicates that sorting is performed on the obtained matrix data “% filtered” using the “a” column as a key.

As in the example of FIG. 3, by performing sorting after deleting some rows from the matrix data, it is expected that the number of rows to be sorted becomes relatively small and the execution time of the program becomes relatively short.

As described above, the optimization of advancing the execution order of the processing of deleting rows or columns of the matrix data is also referred to as pushdown or pushdown optimization.

The communication unit 110 communicates with other apparatuses. For example, the communication unit 110 may receive the source program from another apparatus. The communication unit 110 may transmit the execution result of the source program to another apparatus such as a user terminal apparatus, for example.

The display unit 120 includes a display screen such as a liquid crystal panel or a light emitting diode (LED) panel, for example, and displays various images. For example, the display unit 120 may display the source program or the intermediate representation. The display unit 120 may display the execution result of the source program, for example, by displaying a character string according to a “print” command when the source program is executed.

The operation input unit 130 includes an input device such as a keyboard and a mouse, and receives a user operation. For example, the operation input unit 130 may receive a user operation instructing execution of the source program. In a case where the user generates the source program in the information processing apparatus 100, the operation input unit 130 may receive a user operation of inputting the source program. For example, the display unit 120 may display a screen of an editor for editing a program, and the operation input unit 130 may receive a user operation on the editor. In a case where the program includes a command to receive a user input (input of a value by a user operation), the operation input unit 130 may receive the user input.

The storage unit 180 stores various data. For example, the storage unit 180 may store the program to be executed, the intermediate representation, and various data used when the program is executed. The storage unit 180 is configured using a storage device included in the information processing apparatus 100.

The processing unit 190 controls each unit of the information processing apparatus 100 to perform various types of processing. The function of the processing unit 190 is executed, for example, when a central processing unit (CPU) included in the information processing apparatus 100 reads a program from the storage unit 180 and executes the program.

The front-end unit 210 partially converts the source program into an intermediate representation. The front-end unit 210 executes a portion of the source program that is not converted into the intermediate representation by executing the source program.

The intermediate representation generation unit 211 partially converts the source program into the intermediate representation.

The partial execution unit 212 partially executes the source program. In particular, in a case where it is necessary to partially execute the source program in order to optimize the intermediate representation, the partial execution unit 212 partially executes the source program. For example, in a case where data to be processed needs to be read from a file and referred to in order to optimize the intermediate representation, the partial execution unit 212 reads the data.

The partial execution unit 212 is relevant to an example of a partial execution means.

The determination unit 213 determines whether the intermediate representation can be optimized. The determination unit 213 is relevant to an example of a determination means.

The front-end unit 210 outputs the intermediate representation determined to be optimizable by the determination unit 213 to the middleware unit 220. In this case, the middleware unit 220 optimizes the input intermediate representation.

On the other hand, the front-end unit 210 outputs the intermediate representation determined to be non-optimizable by the determination unit 213 to the back-end unit 230. In this case, the back-end unit 230 executes the intermediate representation at the time of evaluating a variable, an operation, or the like.

The middleware unit 220 performs optimization of the intermediate representation and processing for the optimization.

The optimization unit 221 optimizes the intermediate representation. The optimization performed by the optimization unit 221 can be regarded as conversion from the pre-conversion program to the post-conversion program. The optimization unit 221 is relevant to an example of a conversion means. The information processing apparatus 100 is relevant to an example of a program conversion apparatus.

In a case where the conversion target program converts a plurality of pieces of matrix data into one piece of matrix data and deletes rows or columns of the converted matrix data, the detection unit 222 detects matrix data including partial data used for determining whether to delete individual rows or individual columns among the plurality of pieces of matrix data. The detection unit 222 is relevant to an example of a detection means.

The detection result by the detection unit 222 is used when the middleware unit 220 optimizes the conversion target program to convert a plurality of pieces of matrix data into one piece of matrix data after deleting rows or columns of the matrix data.

The index processing unit 223 generates data used by the detection unit 222 to detect matrix data. The index processing unit 223 is relevant to an example of an index processing means.

The back-end unit 230 performs intermediate representation. The back-end unit 230 is relevant to an example of an execution means.

The function of the back-end unit 230 may be executed using hardware different from the hardware that executes the function of the front-end unit 210.

For example, the information processing apparatus 100 may include an accelerator such as a graphics processing unit (GPU) in addition to the CPU, and the function of the processing unit 190 may be executed using the accelerator in addition to the CPU. Then, the function of the front-end unit 210 may be executed using a CPU, and the function of the back-end unit 230 may be executed using an accelerator such as a GPU.

As described above, when the front-end unit 210 generates the intermediate representation, the back-end unit 230 does not execute the intermediate representation. When the front-end unit 210 executes the source program and requests the back-end unit 230 to execute the intermediate representation for evaluation of variables, operations, or the like, the back-end unit 230 executes the intermediate representation in response to a request from the front-end unit 210.

In a case where the intermediate representation to be executed is the intermediate representation determined to be optimizable by the determination unit 213, the back-end unit 230 executes the intermediate representation optimized by the middleware unit 220. On the other hand, in a case where the intermediate representation is determined to be non-optimizable by the determination unit 213, the back-end unit 230 executes the intermediate representation (non-optimized intermediate representation) generated by the front-end unit 210.

The middleware unit 220 may include the determination unit 213 instead of the front-end unit 210. In this case, the front-end unit 210 outputs the generated intermediate representation to the middleware unit 220. In the middleware unit 220, the optimization unit 221 optimizes the intermediate representation determined to be optimizable by the determination unit 213, and outputs the optimized intermediate representation to the back-end unit 230.

On the other hand, the middleware unit 220 outputs the intermediate representation determined to be non-optimizable by the determination unit 213 to the back-end unit 230 (without performing optimization).

FIG. 4 is a diagram illustrating a second example of the conversion target program. FIG. 4 illustrates a second example of the intermediate representation before being optimized.

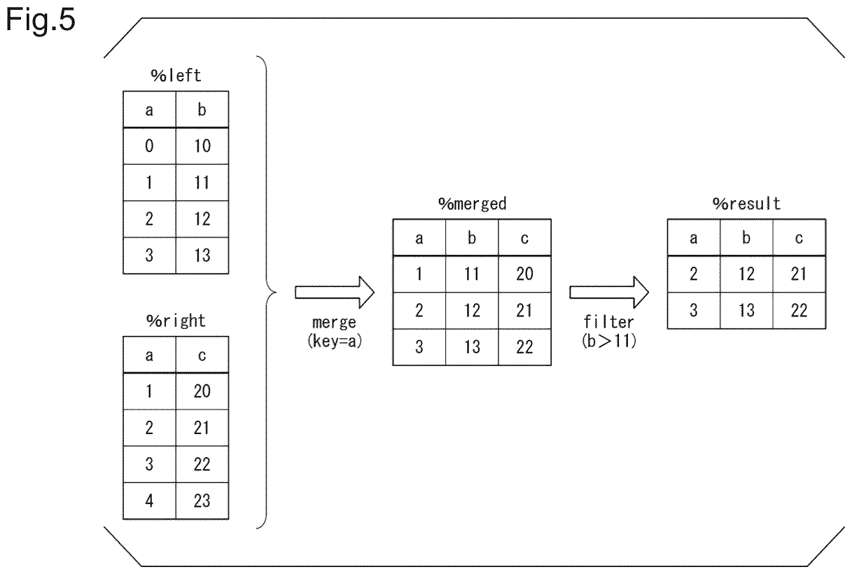

FIG. 5 is a diagram illustrating an example of conversion of matrix data by the conversion target program in FIG. 4.

In the example of FIG. 4, “% merged=merge(% left, % right, “a”)” indicates that the matrix data “% left” and the matrix data “% right” are merged using the column “a” as a key. In the merging, for a plurality of pieces of matrix data, rows having the same key values are put together into one row. The merging is relevant to an example of processing of converting a plurality of pieces of matrix data into one piece of matrix data.

“% col=project(% merged, “b”)”, “% mask=gt(% col, 11)”, and “% result=filter(% merged, % mask)” indicate that a row in which the element value of the “b” column is larger than 11 is extracted from one piece of matrix data “% merged” obtained by merging, and the matrix data “% result” is generated. A series of processes by “project”, “gt”, and “filter” is relevant to an example of processing of deleting partial data in the first direction for one piece of matrix data. Here, row data (data of individual rows) is relevant to an example in the first direction.

The conversion target program in FIG. 4 is relevant to an example of a conversion target program that performs first processing of converting a plurality of pieces of matrix data into one piece of matrix data and then performs second processing of deleting partial data in a first direction in the matrix data for the one piece of matrix data obtained in the first processing.

Here, merging is relevant to an example of the first processing, and a series of processes by “project”, “gt”, and “filter” is relevant to an example of the second processing.

In the example of FIG. 5, a series of processes by “project”, “gt”, and “filter” is referred to as “filter”. As described above, a series of processes by “project”, “gt”, and “filter” is also referred to as “filter”.

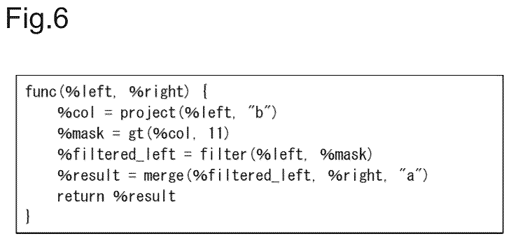

FIG. 6 is a diagram illustrating a second example of the post-conversion program. FIG. 6 illustrates a second example of the optimized intermediate representation. Specifically, FIG. 6 illustrates an example of a post-conversion program obtained by the information processing apparatus 100 performing optimization on the conversion target program of FIG. 4.

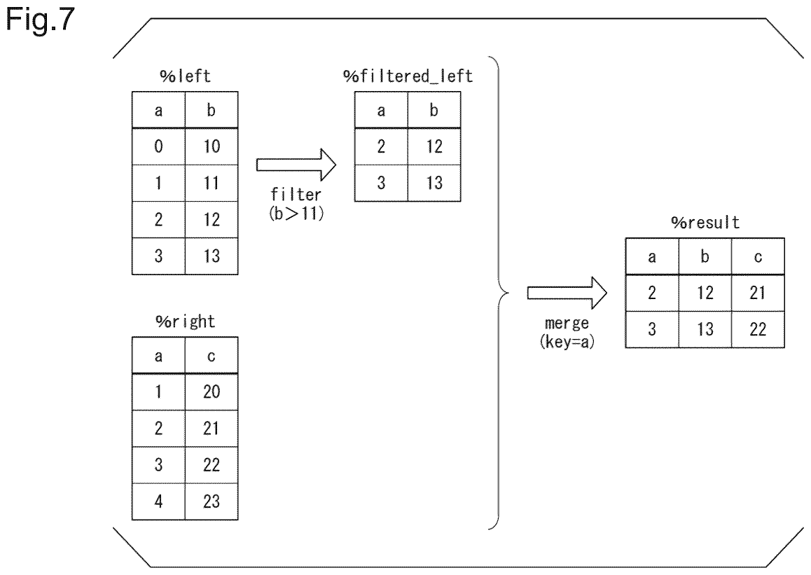

FIG. 7 is a diagram illustrating an example of conversion of matrix data by the post-conversion program in FIG. 6.

In the example of FIG. 6, “% col=project(% left, “b”)”, “% mask =gt(% col, 11)”, and “% filtered_left=filter(% left, % mask)” indicate that a row in which the element value of the “b” column is larger than 11 is extracted from the matrix data “% left” obtained as the argument of the function “func”, and the matrix data “% filtered_left” is generated.

“% result=merge(% filtered_left, % right, “a”)” indicates that the matrix data “% filtered_left” and the matrix data “% right” are merged using the “a” column as a key.

In the conversion from the conversion target program in FIG. 4 to the post-conversion program in FIG. 6, the optimization unit 221 optimizes the intermediate representation so as to perform a series of processes by “project”, “gt”, and “filter” before merging.

In order to perform this optimization, information indicating which of the two pieces of matrix data “% left” and “% right”, obtained as arguments of the function “func”, includes the column “b” used for row deletion, as in “% col=project(% left, “b”)”, is required. This information is not included in the conversion target program.

Therefore, the detection unit 222 refers to two pieces of matrix data “% left” and “% right”, and determines in which of “% left” and “% right” the “b” column is included. In the runtime compilation, when the optimization unit 221 optimizes the conversion target program in FIG. 4, the information processing apparatus 100 acquires two pieces of matrix data “% left” and “% right”. Therefore, the detection unit 222 can acquire and refer to these pieces of matrix data. The detection unit 222 may acquire two pieces of matrix data “% left” and “% right” from the front-end unit 210 or from the back-end unit 230.

The data in the “b” column is relevant to an example of partial data in the second direction used for determining whether to delete individual pieces of partial data in the first direction in the second processing.

The detection unit 222 determining in which of the two pieces of matrix data “% left” and “% right” the “b” column is included can be regarded as detecting the matrix data including the “b” column among the two pieces of matrix data.

Here, the column data (data of individual columns) is relevant to an example of partial data in the second direction. Column names such as column names “a”, “b”, and “c” in the example of FIG. 5 are relevant to an example of a second direction partial data identification index for identifying partial data in the second direction. The row indicating the column name is also referred to as an index row.

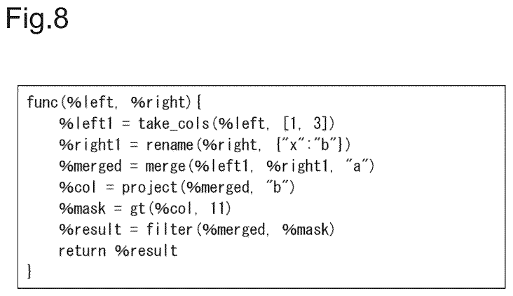

FIG. 8 is a diagram illustrating a third example of the conversion target program. FIG. 8 illustrates a third example of the intermediate representation before being optimized.

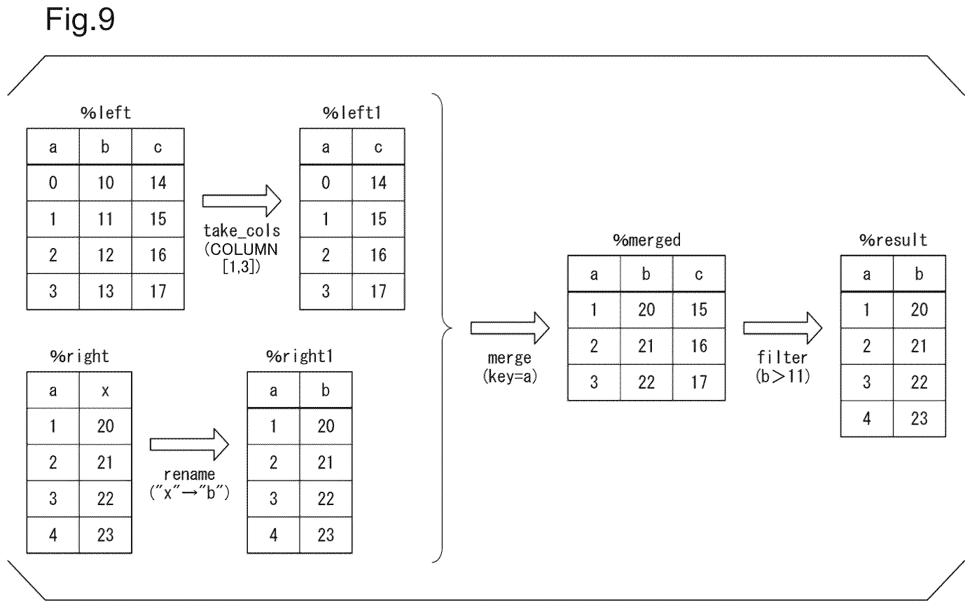

FIG. 9 is a diagram illustrating an example of conversion of matrix data by the conversion target program in FIG. 8.

In the example of FIG. 8, “% left1=take_cols(% left, [1, 3])” indicates that the first and third columns of the matrix data “% left” are extracted and the matrix data “% left1” is generated.

“% right1=rename(% right, {“x”: “b”})” indicates that the column name “x” of the matrix data “% right” is changed to the column name “b”. In the example of FIG. 9, the column name “x” of the matrix data “% right” is the column name “b” of the matrix data “% right1”.

“% merged=merge(% left1, % right1, “a”)” indicates that the matrix data “% left1” and the matrix data “% right1” are merged using the “a” column as a key.

“% col=project(% merged, “b”)”, “% mask=gt(% col, 11)”, and “% result=filter(% merged, % mask)” indicate that a row in which the element value of the “b” column is larger than 11 is extracted from one piece of matrix data “% merged” obtained by merging, and the matrix data “% result” is generated.

The conversion target program in FIG. 8 is relevant to an example of a conversion target program that performs first processing of converting a plurality of pieces of matrix data into one piece of matrix data and then performs second processing of deleting partial data in the first direction in the matrix data for the one piece of matrix data obtained in the first processing.

Here, merging is relevant to an example of the first processing, and a series of processes by “project”, “gt”, and “filter” is relevant to an example of the second processing.

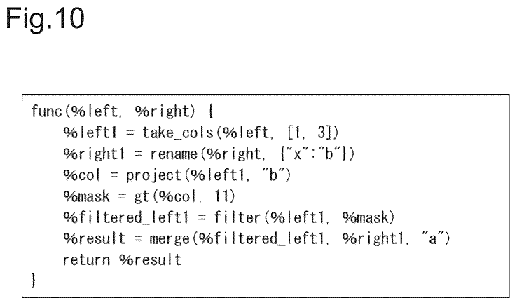

FIG. 10 is a diagram illustrating a third example of the post-conversion program. FIG. 10 illustrates a third example of the optimized intermediate representation. Specifically, FIG. 10 illustrates an example of a post-conversion program obtained by the information processing apparatus 100 performing optimization on the conversion target program of FIG. 8.

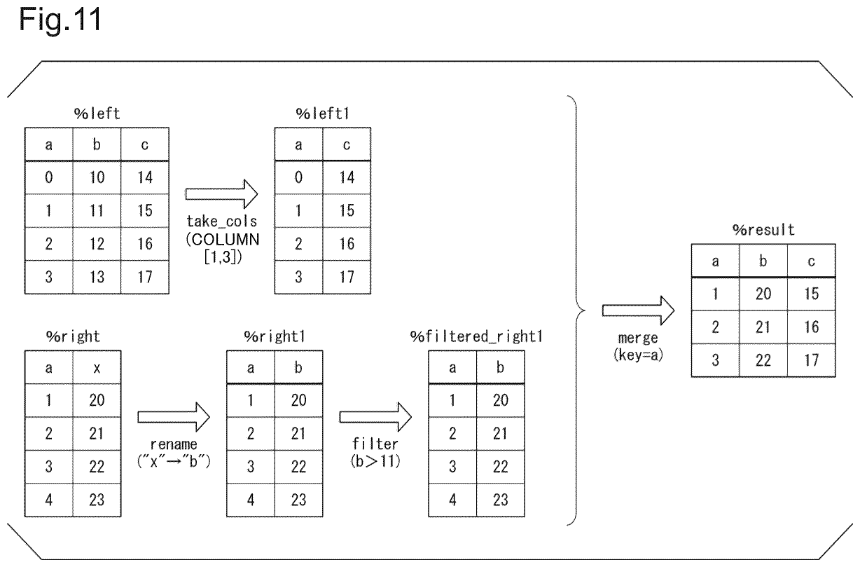

FIG. 11 is a diagram illustrating an example of conversion of matrix data by the post-conversion program in FIG. 10.

In the example of FIG. 10, “% left1=take_cols(% left, [1, 3])” and “% right1=rename(% right, {“x”: “b”})” are similar to those in the case of FIG. 8.

“% col=project(% reft1, “b”)”, “% mask=gt(% col, 11)”, and “% filtered_left1=filter(% left1, % mask)” indicate that a row in which the element value of the “b” column is larger than 11 is extracted from the matrix data “% left1”, and the matrix data “% filtered_left1” is generated.

“% result=merge(% filtered_left1, % right1, “a”)” indicates that the matrix data “% filtered_left1” and the matrix data “% right1” are merged using the “a” column as a key.

In the conversion from the conversion target program in FIG. 8 to the post-conversion program in FIG. 10, the optimization unit 221 optimizes the intermediate representation so as to perform a series of processes by “project”, “gt”, and “filter” before merging.

In order to perform this optimization, information indicating which of the two pieces of matrix data “% left1” and “% right1” includes the column “b” used for row deletion, as in “% col=project(% reft1, “b”)”, is required. This information is not included in the conversion target program.

The two pieces of matrix data “% left1” and “% right1” are matrix data obtained by applying a command to the two pieces of matrix data “% left” and “% right” obtained as arguments of the function “func”. Therefore, by referring to the two pieces of matrix data “% left” and “% right” obtained as arguments of the function “func”, it is not possible to determine which of the two pieces of matrix data “% left1” and “% right1” includes the column “b”.

Therefore, the index processing unit 223 acquires two pieces of matrix data “% left” and “% right”, and extracts column names of the two pieces of matrix data.

Then, the index processing unit 223 performs processing “% left1=take_cols(% left, [1, 3])” of generating the matrix data “% left1” from the matrix data “% left” on the column name of the matrix data “% left” in the conversion target program in FIG. 8 to acquire the column name of the matrix data “% left1”. In the case of the examples of FIGS. 8 to 11, the processing “% left1=take_cols(% left, [1, 3])” does not affect the column name. Therefore, the index processing unit 223 acquires “a” and “b” as the column names of the matrix data “% left1”.

The index processing unit 223 performs processing “% right1=rename(% right, {“x”: “b”})” of generating the matrix data “% right1” from the matrix data “% right” on the column name of the matrix data “% right” in the conversion target program of FIG. 8, and acquires the column name of the matrix data “% right1”. In the case of the examples of FIGS. 8 to 11, “x” is not included in the column name of the matrix data “% right”, and the processing “% right1=rename(% right, {“x”: “b”})” does not affect the column name. Therefore, the index processing unit 223 acquires “a” and “c” as the column names of the matrix data “% right1”.

Then, the detection unit 222 refers to the column names “a” and “b” of the matrix data “% left1” and the column names “a” and “c” of the matrix data “% right1”, and determines that the “b” column is included in the matrix data “% left1”.

The data in the “b” column is relevant to an example of partial data in the second direction used for determining whether to delete individual pieces of partial data in the first direction in the second processing.

The detection unit 222 determining in which of the two pieces of matrix data “% left1” and “% right1” the “b” column is included can be regarded as detecting the matrix data including the “b” column among the two pieces of matrix data.

Here, the column data (data of individual columns) is relevant to an example of partial data in the second direction. Column names such as column names “a”, “b”, and “c” in the example of FIG. 9 are relevant to an example of a second direction partial data identification index for identifying partial data in the second direction.

“% left1=take_cols(% left, [1, 3])” and “% right1=rename(% right, {“x”: “b”})” are relevant to an example of processing on the matrix data, which is performed on the second direction partial data identification index in each of the plurality of pieces of matrix data.

The column names “a” and “c” of the matrix data “% left1” and the column names “a” and “b” of the matrix data “% right1” are relevant to examples of the second direction partial data identification index in each of the plurality of pieces of matrix data to be subjected to the first processing in the post-conversion program.

The index processing unit 223 may perform “% left1=take_cols(% left, [1,3])” on the entire matrix data “% left” and perform “% right1=rename(% right, {“x”: “b”})” on the entire matrix data “% right”. As a result, the index processing unit 223 can acquire the column name of the matrix data “% left1” and the column name of the matrix data “% right1”.

In this case, since the matrix data “% left1” and “% right1” are obtained by the processing performed by the index processing unit 223, it is conceivable that the optimization unit 221 generates an intermediate representation relevant to “% col=project(% left1, “b”)”, “% mask=gt(% col, 11)”, “% filtered_left1=filter(% left1, % mask)”, “% result=merge(% filtered_left1, % right1, “a”)”, and “return % result” in FIG. 10.

On the other hand, as described above, by the index processing unit 223 performing the processing on each of the column name of the matrix data “% left” and the column name of “% right”, it is expected that the processing time will be shorter than the case of performing the processing on each of the entire matrix data “% left” and the entire matrix data “% right”.

For the “% left1=take_cols(% left, [1,3])” and the “% right1=rename(% right, {“x”: “b”})”, when the back-end unit 230 performs these processes such as in a case where the back-end unit 230 is specialized in matrix calculation, the processing time is expected to be shorter than a case where the index processing unit 223 performs these processes.

As described above, by the index processing unit 223 performing the processing on the column name of the matrix data, the processing time is expected to be shorter than that in a case where the processing is performed on the entire matrix data.

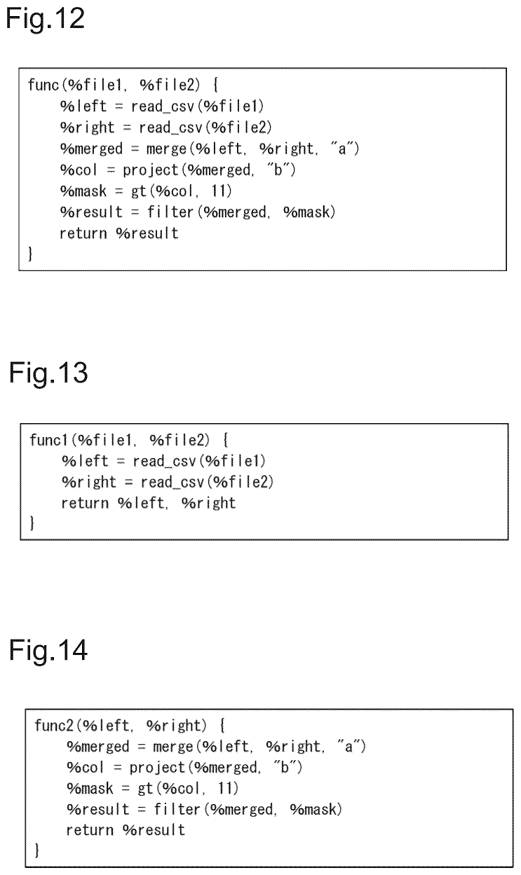

FIG. 12 is a diagram illustrating a fourth example of the conversion target program. FIG. 12 illustrates a fourth example of the intermediate representation before being optimized.

In the example of FIG. 12, “% left=read_csv(% file1)” indicates that the matrix data “% left” is read from the file “% file1” when the intermediate representation is executed.

“% right=read_csv(% file2)” indicates that the matrix data “% right” is read from the file “% file2” when the intermediate representation is executed.

“% merged=merge(% left, % right, “a”)” indicates that the matrix data “% left” and the matrix data “% right” are merged using the “a” column as a key.

“% col=project(% merged, “b”)”, “% mask=gt(% col, 11)”, and “% result=filter(% merged, % mask)” indicate that a row in which the element value of the “b” column is larger than 11 is extracted from one piece of matrix data “% merged” obtained by merging, and the matrix data “% result” is generated.

The conversion target program in FIG. 12 is relevant to an example of a conversion target program that performs first processing of converting a plurality of pieces of matrix data into one piece of matrix data and then performs second processing of deleting partial data in the first direction in the matrix data for the one piece of matrix data obtained in the first processing.

Here, merging is relevant to an example of the first processing, and a series of processes by “project”, “gt”, and “filter” is relevant to an example of the second processing.

In the intermediate representation of FIG. 12 (the conversion target program of FIG. 12), “% left=read_csv(% file1)” and “% right=read_csv(% file2)” are executed when the intermediate representation is executed. On the other hand, the optimization unit 221 optimizes the intermediate representation before executing the intermediate representation. Therefore, in the intermediate representation of FIG. 12, the information processing apparatus 100 cannot obtain the column name of the matrix data “% left” and the column name of the matrix data “% right”, which are information necessary for optimization, at the time of optimization of the intermediate representation.

Therefore, the partial execution unit 212 separates the processing of reading data from the intermediate representation, and executes data reading before optimization by the optimization unit 221. The optimization unit 221 optimizes the intermediate representation other than data reading.

FIG. 13 is a diagram illustrating an example of intermediate representation of data reading.

FIG. 14 is a diagram illustrating an example of intermediate representation other than data reading.

The partial execution unit 212 separates “% left=read_csv(% file1)” and “% right=read_csv(% file2)” from the intermediate representation in FIG. 12, thereby dividing the intermediate representation in FIG. 12 into the intermediate representation in FIG. 13 and the intermediate representation in FIG. 14. Then, the partial execution unit 212 executes the intermediate representation of FIG. 13 before the optimization unit 221 optimizes the intermediate representation of FIG. 14.

As a result, the optimization unit 221 can refer to the matrix data “% left” and “% right” when optimizing the intermediate representation of FIG. 14, and can optimize the intermediate representation similarly to the case of the examples of FIGS. 4 to 8.

In a case where the conversion target program performs processing on the read matrix data after reading the matrix data and then performs first processing such as merging (processing of converting a plurality of pieces of matrix data into one piece of matrix data), the index processing unit 223 may perform processing on the second direction partial data identification index (for example, a column name) of the read matrix data, similarly to the example of FIGS. 8 to 11.

As in the example of FIG. 12, in a case where the matrix data is read by the conversion target program, the partial execution unit 212 may read only the second direction partial data identification index (for example, a column name) of the matrix data. In this case, the partial execution unit 212 rewrites the intermediate representation to be optimized so that the reading of the matrix data and the previously read second direction partial data identification index (for example, a column name) are associated with each other.

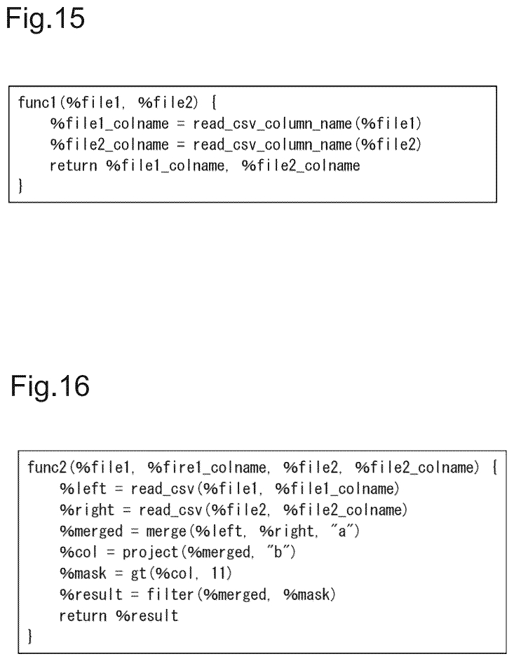

FIG. 15 is a diagram illustrating an example of intermediate representation of reading the column name of the matrix data.

FIG. 16 is a diagram illustrating an example of an intermediate representation in which reading of matrix data and column names are rewritten so as to be associated with each other.

The partial execution unit 212 extracts “% left=read_csv(% file1)” and “% right=read_csv(% file2)” from the intermediate representation in FIG. 12, replaces “read_csv” with “read_csv_column_name” that reads only the column name of the matrix data, and generates the intermediate representation in FIG. 15.

The partial execution unit 212 rewrites the intermediate representation of FIG. 12 as the intermediate representation of FIG. 16 to be optimized.

In the example of FIG. 16, “% left=read_csv(% file1, % file1_colname)” indicates that “% left=read_csv(% file1)” for reading matrix data “% left” from the file “% file1” and data “% file1_colname” indicating a column name of the matrix data “% left” are associated with each other.

“% right=read_csv(% file2, % file2_colname)” indicates that “% right=read_csv(% file2)” for reading matrix data “% right” from the file “% file2” is associated with data “% file2_colname” indicating a column name of the matrix data “% right”.

In the example of FIG. 16, as arguments of the function “func2”, data “% file1_colname” indicating a column name of the matrix data “% left” and data “% file2_colname” indicating a column name of the matrix data “% right” are explicitly indicated.

Then, the partial execution unit 212 executes the intermediate representation of FIG. 15 before the optimization unit 221 optimizes the intermediate representation of FIG. 16.

The optimization unit 221 can optimize the intermediate representation in FIG. 16 by referring to the data “% file1_colname” indicating the column name of the matrix data “% left” and the data “% file2_colname” indicating the column name of the matrix data “% right”, which are obtained by the partial execution unit 212 executing the intermediate representation in FIG. 15.

Comparing the examples of FIGS. 12 to 14 with the examples of FIGS. 12, 15, and 16, it is considered that the time required to execute the intermediate representation is shorter in a case where the partial execution unit 212 executes the intermediate representation of FIG. 16 than a case where it executes the intermediate representation of FIG. 14. Therefore, in the examples of FIGS. 12, 15, and 16, the optimization unit 221 can start the optimization of the intermediate representation at an earlier timing than the examples of FIGS. 12 to 14.

For example, in a case where it is considered that an idling time (waiting time for not performing processing) of the optimization unit 221 occurs, as in the examples of FIGS. 12, 15, and 16, the partial execution unit 212 reads only the second direction partial data identification index (for example, a column name) of the matrix data, so that the optimization unit 221 can be effectively used, and in this respect, efficiency of runtime compilation performed by the information processing apparatus 100 can be improved.

Next, a case where not only column names but also row names are indicated in the matrix data will be considered.

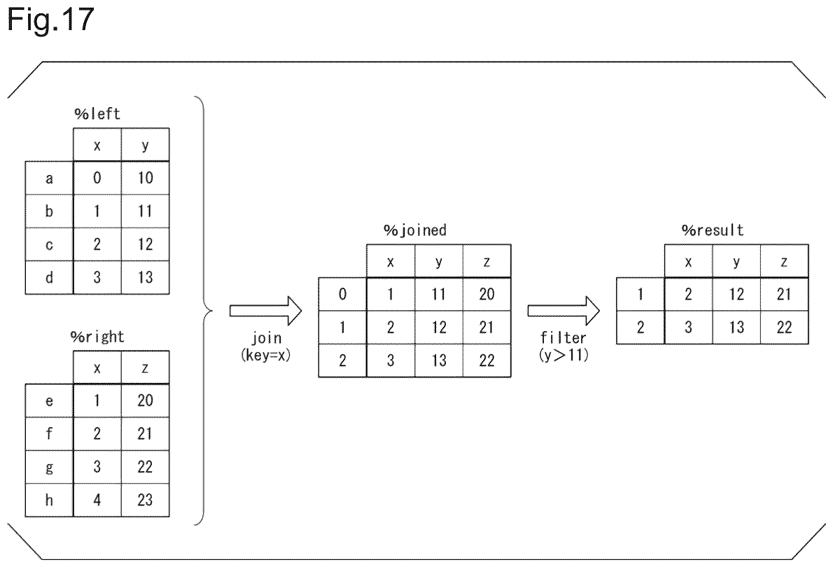

FIG. 17 is a diagram illustrating a first example of the conversion of the matrix data by the conversion target program in a case where the row name is indicated in the matrix data.

In the example of FIG. 17, the matrix data “% left” and the matrix data “% right” are joined using the “x” column as a key, and a row in which the element value of the “b” column is larger than 11 is extracted from the obtained matrix data “% joined” to generate the matrix data “% result”.

Here, in the join, it is assumed that, for a plurality of pieces of matrix data, rows having the same key values are put together into one row, and a row name is assigned to each row of the obtained one piece of matrix data. In the example of FIG. 17, row names of “0”, “1”, and “2” are assigned to matrix data “% joined” obtained by join. The assignment of the row name in the join can be regarded as reassignment of the row name from the row name in the plurality of pieces of matrix data to be joined. A column indicating a row name is also referred to as an index column.

In the example of FIG. 17, a row number starting from 0 is assigned as a row name in the join, and the index column is not to be identified by the column name.

The reassignment of the column name to the matrix data like the assignment of the column name in the join is also referred to as resetting of the index column. A command for resetting the index is also referred to as a reset command.

In the example of FIG. 17, the join is relevant to an example of first processing of converting a plurality of pieces of matrix data into one piece of matrix data and reassigning a first direction partial data identification index for identifying partial data in the first direction in the converted matrix data.

Here, the row data is relevant to an example of partial data in the first direction, and the row name is relevant to an example of a first direction partial data identification index.

The processing of extracting a row in which the element value of the “y” column is larger than 11 from the matrix data “% joined” and generating the matrix data “% result” is relevant to an example of the second processing of deleting partial data in the first direction.

The intermediate representation indicating the processing in the example of FIG. 17 is relevant to an example of a conversion target program in which the first processing of converting a plurality of pieces of matrix data into one piece of matrix data and reassigning a first direction partial data identification index for identifying partial data in the first direction in the converted matrix data is performed, and then the second processing of deleting partial data in the first direction is performed on one piece of matrix data obtained in the first processing.

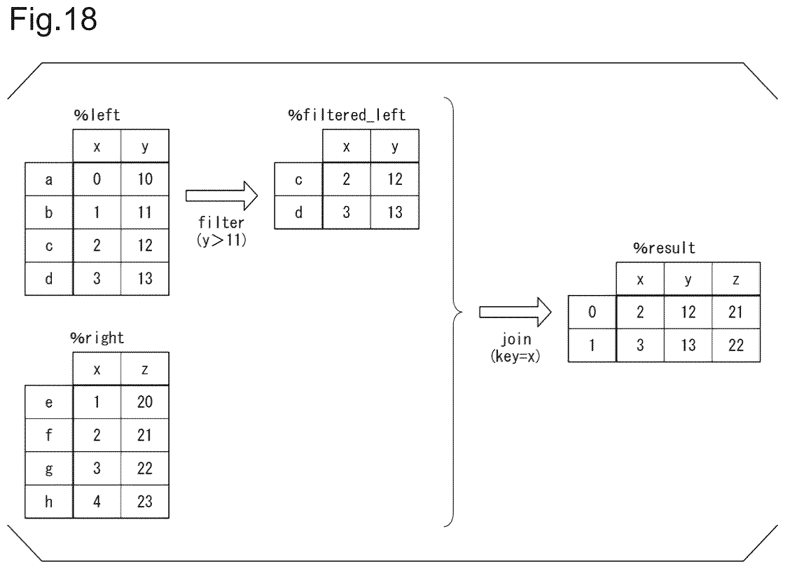

FIG. 18 is a diagram illustrating a second example of the conversion of the matrix data by the conversion target program in a case where the row name is indicated in the matrix data. FIG. 18 illustrates an example of a case where the execution order of the processing is changed so as to perform the first processing after performing the second processing from the example of FIG. 17.

In the example of FIG. 18, the matrix data “% filtered_left” is generated by extracting a row in which the element value of the “y” column is larger than 11 from the matrix data “% left”. Then, the matrix data “% filtered_left” and the matrix data “% right” are joined using the “x” column as a key to generate the matrix data “% result”.

Also in the example of FIG. 18, a row number starting from 0 is assigned as a row name in the join, and the index column is not to be identified by the column name.

Comparing the example of FIG. 17 with the example of FIG. 18, in the example of FIG. 17, the row names of the matrix data “% result” are “1” and “2”, whereas in the example of FIG. 18, the row names of the matrix data “% result” are “0” and “1”.

Here, a case where the intermediate representation indicating the processing in the example of FIG. 17 is converted into the intermediate representation indicating the processing in the example of FIG. 18 will be considered.

In this case, when the processing depending on the row name of the matrix data “% result” is performed, the result of the processing depending on the row name of the matrix data “% result” is different between the example of FIG. 17 (in a case where the conversion of the intermediate representation is not performed) and the example of FIG. 18 (in a case where the conversion of the intermediate representation is performed).

Therefore, the determination unit 213 determines whether both the following first condition and second condition are satisfied for the conversion target program.

First condition: the conversion target program does not include the processing depending on the first direction partial data identification index, or the result of the processing depending on the first direction partial data identification index is the same between the conversion target program and the post-conversion program converted to perform the first processing after performing the second processing on the matrix data detected by the detection unit 222 from the conversion target program.

Second condition: the first direction partial data identification index indicated in the execution result of the conversion target program is the same as the first direction partial data identification index indicated in the execution result of the post-conversion program.

The first condition is a condition for ensuring that the processing results in the conversion target program or the post-conversion program are the same between a case where the optimization unit 221 optimizes the conversion target program and a case where the optimization unit does not optimize the conversion target program.

The second condition is a condition for ensuring that the result of processing using the processing result by the conversion target program or the post-conversion program is the same between a case where the optimization unit 221 optimizes the conversion target program and a case where the optimization unit does not optimize the conversion target program.

The optimization unit 221 optimizes the conversion target program under the necessary condition that the determination unit 213 determines that both the first condition and the second condition are satisfied. That is, in a case where the determination unit 213 does not determine that both the first condition and the second condition are satisfied (for example, in a case where the determination unit 213 determines that either the first condition or the second condition is not satisfied), the optimization unit 221 does not perform optimization on the conversion target program.

On the other hand, in a case where the determination unit 213 determines that both the first condition and the second condition are satisfied, the optimization unit 221 may optimize the conversion target program. Alternatively, in addition to the determination unit 213 determining that both the first condition and the second condition are satisfied, the optimization unit 221 may optimize the conversion target program in a case where it is determined that some condition is satisfied (for example, the processing time is shortened when the optimization is performed than a case where the optimization is not performed).

The determination unit 213 may determine whether both the following third condition and fourth condition are satisfied as the determination of the sufficient condition that both the first condition and the second condition are satisfied.

Third condition: in the conversion target program, after the first processing, the second processing is performed without branching of the processing, and the reassignment of the first direction partial data identification index is performed in all the processing paths after the first processing and the second processing are performed.

Fourth condition: in all the processing paths after the first processing and the second processing are performed, the processing depending on the first direction partial data identification index is not included between the second processing and the reassignment of the first direction partial data identification index.

The third condition is a condition for ensuring that the rearrangement of the execution order of the first processing and the second processing does not affect the first direction partial data identification index of the matrix data after the reassignment of the first direction partial data identification index is performed. By reassigning the first direction partial data identification indexes, the subsequent first direction partial data identification indexes become the same in a case where the execution order of the first processing and the second processing is rearranged and in a case where the execution order is not rearranged.

The fourth condition is a condition for ensuring that the rearrangement of the execution order of the first processing and the second processing does not affect the first direction partial data identification index of the matrix data until the reassignment of the first direction partial data identification index is performed.

That both the third condition and the fourth condition are satisfied is relevant to a sufficient condition that the first condition is satisfied. That the third condition is satisfied is relevant to a sufficient condition that the second condition is satisfied.

In a case where the determination unit 213 determines whether both the third condition and the fourth condition are satisfied, the optimization unit 221 optimizes the conversion target program under the necessary condition that the determination unit 213 determines that both the third condition and the fourth condition are satisfied.

In the fourth condition, it is assumed that no processing (command) is provided between the first processing and the second processing in the conversion target program, or the processing between the first processing and the second processing is still executed after the first processing in the optimization performed by the optimization unit 221. In the optimization performed by the optimization unit 221, in a case where the processing between the first processing and the second processing may be executed before the first processing, the fourth condition may be replaced with the following fifth condition.

Fifth condition: in all the processing paths after the first processing and the second processing are performed, the processing depending on the first direction partial data identification index is not included between the first processing and the reassignment of the first direction partial data identification index.

In the third condition, the condition “the second processing is performed without branching of the processing after the first processing” can be regarded as a condition for the conversion target program to be a target of optimization in which the execution order of the first processing and the second processing is rearranged.

The determination unit 213 or the optimization unit 221 may determine “whether the second processing is performed without branching of the processing after the first processing in the conversion target program” commonly in a case where the first direction partial data identification index is provided in the matrix data and in a case where the first direction partial data identification index is not provided in the matrix data. In this case, the determination unit 213 does not need to determine “whether the second processing is performed without branching of the processing after the first processing in the conversion target program” again in the determination on whether optimization can be performed in a case where the first direction partial data identification index is provided in the matrix data.

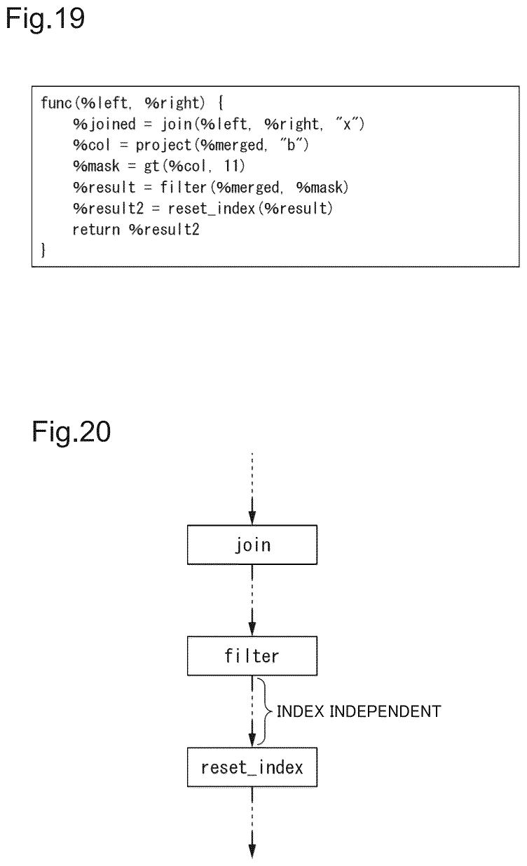

FIG. 19 is a diagram illustrating an example of the execution target program satisfying both the third condition and the fourth condition.

In the example of FIG. 19, “% joined=join(% left, % right, “x”)” indicates that the matrix data “% left” and the matrix data “% right” are joined using the “x” column as a key.

“% col=project(% merged, “b”)”, “% mask=gt(% col, 11)”, and “% result=filter(% merged, % mask)” indicate that rows having element values of the “b” column greater than 11 are extracted from the matrix data “% joined” obtained by join, and the matrix data “% result” is generated.

“% result2=reset_index (% result)” indicates that the index column of the matrix data “% result” is reset. “reset_index” is relevant to an example of a reset command.

In the example of FIG. 19, the join is relevant to an example of the first processing, and a series of processes by “project”, “gt”, and “filter” is relevant to an example of the second processing.

Each element (that is, a row name for each row) of the index column is relevant to an example of the first direction partial data identification index. The resetting of the index column by “reset_index” is relevant to an example of the reassignment of the first direction partial data identification index.

In the conversion target program in FIG. 19, after the join, a series of processes by “project”, “gt”, and “filter” is executed without a process branch, and then “reset_index” is executed without a process branch. Therefore, in the conversion target program of FIG. 19, the third condition is satisfied.

In the conversion target program in FIG. 19, there is one processing path after performing the join and the series of processes by “project”, “gt”, and “filter” relevant to the example of the first processing. Then, in the path, processing is not included between the series of processes by “project”, “gt”, and “filter” and “reset_index”, and thus processing depending on the first direction partial data identification index is not included. Therefore, in the conversion target program of FIG. 19, the fourth condition is satisfied.

FIG. 20 is a diagram illustrating an example of a case where both the third condition and the fourth condition are satisfied.

In the example of FIG. 20, “join” is relevant to an example of the first processing. “filter” is relevant to an example of the second processing. “reset_index” is relevant to an example of a reset command.

In the example of FIG. 20, processing depending on the index column is not included between “filter” and “reset_index”.

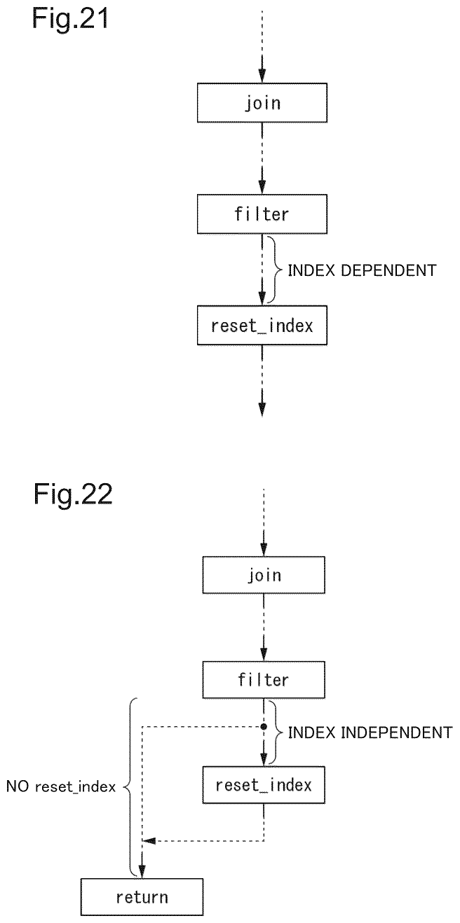

FIG. 21 is a diagram illustrating a first example in a case where either the third condition or the fourth condition is not satisfied.

In the example of FIG. 21, “join” is relevant to an example of the first processing. “filter” is relevant to an example of the second processing. “reset_index” is relevant to an example of a reset command.

In the example of FIG. 21, processing depending on the index column is included between “filter” and “reset_index”.

In the example of FIG. 21, the fourth condition is not satisfied.

FIG. 22 is a diagram illustrating a second example in a case where either the third condition or the fourth condition is not satisfied.

In the example of FIG. 22, “join” is relevant to an example of the first processing. “filter” is relevant to an example of the second processing. “reset_index” is relevant to an example of a reset command.

In the example of FIG. 22, there is a processing path on which “reset_index” is not executed after “join” and “filter” are executed.

In the example of FIG. 22, the third condition is not satisfied.

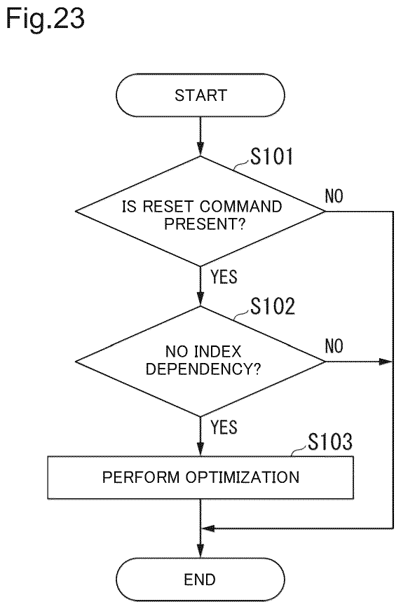

FIG. 23 is a diagram illustrating an example of a procedure of processing in which the information processing apparatus 100 optimizes an optimization target program that handles matrix data in which an index column is provided.

In the example of FIG. 23, the determination unit 213 determines whether there is a reset command in all the processing paths after the first processing and the second processing in the conversion target program (step S101).

In a case where the determination unit 213 determines that there is a processing path having no reset command among the processing paths after the first processing and the second processing (step S101: NO), the information processing apparatus 100 ends the processing of FIG. 23.

On the other hand, in a case where it is determined in step S101 that there is the reset command in all the processing paths after the first processing and the second processing (step S101: YES), the determination unit 213 determines whether there is no processing depending on the index column between the second processing and the reset command in all the processing paths after the first processing and the second processing (step S102).

In a case where the determination unit 213 determines that there is a processing path having processing depending on the index column between the second processing and the reset command (step S102: NO), the information processing apparatus 100 ends the processing of FIG. 23.

On the other hand, in step S102, in a case where the determination unit 213 determines that there is no processing depending on the index column between the second processing and the reset command in all the processing paths after the first processing and the second processing (step S102: YES), the optimization unit 221 optimizes the conversion target program (step S103).

After step S103, the information processing apparatus 100 ends the processing of FIG. 23.

The optimization unit 221 may repeatedly perform optimization of rearranging the execution order of the first processing and the second processing.

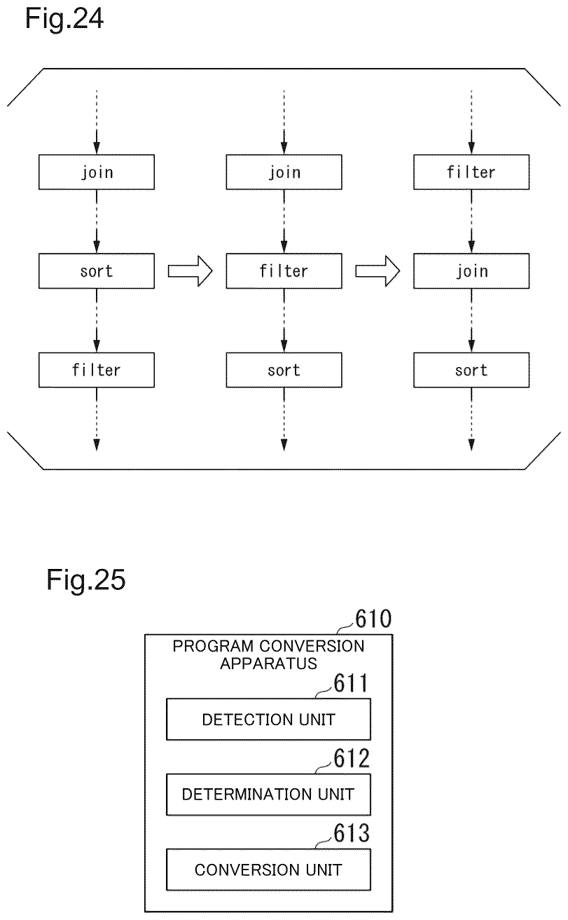

FIG. 24 illustrates an example of a case where the optimization unit 221 repeatedly performs optimization of rearranging the execution order of the first processing and the second processing.

In the example of FIG. 24, both “join” and “sort” are relevant to an example of the first processing. “filter” is relevant to an example of the second processing.

In the example of FIG. 24, in the conversion target program, “sort” is executed after “join”, and then “filter” is executed.

On the other hand, the optimization unit 221 changes the conversion target program to execute “filter” after “join” and then execute “sort” in the first optimization.

Further, the optimization unit 221 performs the second optimization on the program after the first optimization, executes “join” after “filter”, and then executes “sort”.

As described above, the detection unit 222 converts a plurality of pieces of matrix data into one piece of matrix data, and detects matrix data including partial data in the second direction (for example, column data) used for determining whether to delete individual pieces of partial data in the first direction in the second processing among the plurality of pieces of matrix data, with respect to a conversion target program for performing the second processing (for example, filter) of deleting the partial data in the first direction with respect to one piece of matrix data obtained in the first processing after performing the first processing (for example, join) of reassigning the first direction partial data identification index (for example, an index column) for identifying the partial data (for example, row data) in the first direction in the converted matrix data.

The determination unit 213 determines whether both the first condition that the processing depending on the first direction partial data identification index is not included in the conversion target program or the first condition that the result of the processing depending on the first direction partial data identification index is the same in the conversion target program and the post-conversion program converted so as to perform the first processing after performing the second processing on the detected matrix data from the conversion target program, and the second condition that the first direction partial data identification index indicated in the execution result of the conversion target program and the first direction partial data identification index indicated in the execution result of the post-conversion program are the same, are satisfied.

The optimization unit 221 converts the conversion target program into the post-conversion program under the necessary condition that it is determined that both the first condition and the second condition are satisfied.

According to the information processing apparatus 100, it is possible to perform optimization of changing the execution order of processing for a program that handles data in a matrix format.

In particular, according to the information processing apparatus 100, it is possible to determine whether optimization of changing the execution order of processing can be performed in a case where the conversion target program handles the matrix data to which the first direction partial data identification index is assigned. Then, in a case where it is determined that the optimization of changing the execution order of the processing can be performed, the information processing apparatus 100 can execute the optimization. According to the information processing apparatus 100, in this respect, it is possible to detect a relatively large number of cases where optimization of changing the execution order of processing can be performed for a program that handles data in a matrix format.

As the determination of the sufficient condition as to whether both the first condition and the second condition are satisfied, the determination unit 213 determines whether both the third condition that the second processing is to be performed without branching of the processing after the first processing in the conversion target program and the reassignment of the first direction partial data identification index is to be performed in all the processing paths after the first processing and the second processing are performed, and the fourth condition that the processing depending on the first direction partial data identification index is not included between the second processing and the reassignment of the first direction partial data identification index in all the processing paths after the first processing and the second processing are performed, are satisfied.

The optimization unit 221 converts the conversion target program into a post-conversion program that performs the first processing after performing the second processing on the detected matrix data, under the necessary condition that it is determined that both the third condition and the fourth condition are satisfied.

According to the information processing apparatus 100, it is possible to determine whether optimization of the processing target program is possible with reference to the processing path in the processing target program and the presence or absence of dependency of processing included in the processing target program on the first direction partial data identification index. In particular, according to the information processing apparatus 100, it is possible to determine whether optimization of the processing target program is possible without referring to processing executed after execution of the processing target program.

The detection unit 222 refers to a second direction partial data identification index (for example, a column name) for identifying partial data in the second direction in each of the plurality of pieces of matrix data, and detects matrix data including partial data in the second direction used for determining whether to delete individual pieces of partial data in the first direction in the second processing, among the plurality of pieces of matrix data.

According to the information processing apparatus 100, by rearranging the execution order of the first processing and the second processing so as to perform the second processing on the matrix data detected by the detection unit 222, it is possible to perform optimization of changing the execution order of processing for a program that handles data in a matrix format.

The detection unit 222 refers to the second direction partial data identification index by referring to a plurality of pieces of matrix data input to the conversion target program.

According to the information processing apparatus 100, even in a case where it is difficult to determine which matrix data among the plurality of pieces of matrix data is to be applied in the post-conversion program only from the conversion target program, optimization of rearranging the execution order of the first processing and the second processing may be performed.

In particular, according to the information processing apparatus 100, in a case where the first processing is performed on the plurality of pieces of matrix data input as arguments to the conversion target program in the conversion target program, the matrix data to which the second processing is applied in the post-conversion program can be detected by referring to the plurality of pieces of matrix data input as arguments to the conversion target program, and the conversion target program can be optimized.

In the runtime compilation, when the optimization unit 221 optimizes the change target program, the information processing apparatus 100 knows the values of the plurality of pieces of matrix data input as arguments to the conversion target program. As a result, the information processing apparatus 100 can detect the matrix data to which the second processing is applied in the post-conversion program with reference to the plurality of pieces of matrix data input as arguments to the conversion target program.

The index processing unit 223 performs processing on the matrix data in the conversion target program for the second direction partial data identification index in each of the plurality of pieces of matrix data, thereby acquiring the second direction partial data identification index in each of the plurality of pieces of matrix data to be subjected to the first processing (for example, merge) in the post-conversion program.

The detection unit 222 detects matrix data including partial data in the second direction used for determining whether to delete individual pieces of partial data in the first direction in the second processing among the plurality of pieces of matrix data by referring to the second direction partial data identification index in each of the plurality of pieces of matrix data to be subjected to the first processing in the post-conversion program.

According to the information processing apparatus 100, even in a case where it is difficult to determine which matrix data among the plurality of pieces of matrix data is to be applied in the post-conversion program only from the conversion target program, optimization of rearranging the execution order of the first processing and the second processing may be performed.

In particular, according to the information processing apparatus 100, in a case where the processing is applied to the plurality of pieces of matrix data input as arguments to the conversion target program or a part of the plurality of pieces of matrix data in the conversion target program and then the first processing is performed on the plurality of pieces of matrix data in the conversion target program, the detection unit 222 can detect the matrix data to which the second processing is applied in the post-conversion program with reference to the second direction partial data identification index to which the processing is applied.

In that the index processing unit 223 performs processing on the second direction partial data identification index, the processing time is expected to be shorter than that in a case where the processing is performed on the entire matrix data.

The partial execution unit 212 executes processing of reading data in the conversion target program, and acquires information indicating the second direction partial data identification index in each of the plurality of pieces of matrix data to be subjected to the first processing.

According to the information processing apparatus 100, even in a case where it is difficult to determine which matrix data among the plurality of pieces of matrix data is to be applied in the post-conversion program only from the conversion target program, optimization of rearranging the execution order of the first processing and the second processing may be performed.

In particular, according to the information processing apparatus 100, in a case where the first processing is applied to the matrix data read from the file or the like in the processing target program, the partial execution unit 212 executes processing of reading data, so that the detection unit 222 can detect the matrix data to which the second processing is applied in the post-conversion program.

The partial execution unit 212 executes processing of reading a second direction partial data identification index in the matrix data for a command to read data in the conversion target program, and acquires information indicating the second direction partial data identification index in each of the plurality of pieces of matrix data to be subjected to the first processing.

According to the information processing apparatus 100, even in a case where it is difficult to determine which matrix data among the plurality of pieces of matrix data is to be applied in the post-conversion program only from the conversion target program, optimization of rearranging the execution order of the first processing and the second processing may be performed.

In particular, according to the information processing apparatus 100, in a case where the first processing is applied to the matrix data read from the file or the like in the processing target program, the partial execution unit 212 reads the second direction partial data identification index, so that the detection unit 222 can detect the matrix data to which the second processing is applied in the post-conversion program.

In that the partial execution unit 212 reads the second direction partial data identification index, the processing time is expected to be shorter than that in a case where the entire matrix data is read.

### Second Example Embodiment

FIG. 25 is a diagram illustrating an example of a configuration of a program conversion apparatus according to at least one example embodiment. In the configuration illustrated in FIG. 25, a program conversion apparatus 610 includes a detection unit 611, a determination unit 612, and a conversion unit 613.

In such a configuration, the detection unit 611 converts a plurality of pieces of matrix data into one piece of matrix data, performs first processing of reassigning a first direction partial data identification index for identifying partial data in a first direction in the converted matrix data, and then detects matrix data including partial data in a second direction used for determining whether to delete individual pieces of partial data in the first direction in the second processing among the plurality of pieces of matrix data with respect to a conversion target program for performing second processing of deleting the partial data in the first direction with respect to one piece of matrix data obtained in the first processing.

The determination unit 612 determines whether both the first condition that the processing depending on the first direction partial data identification index is not included in the conversion target program or the first condition that the result of the processing depending on the first direction partial data identification index is the same in the conversion target program and the post-conversion program converted so as to perform the first processing after performing the second processing on the detected matrix data from the conversion target program, and the second condition that the first direction partial data identification index indicated in the execution result of the conversion target program and the first direction partial data identification index indicated in the execution result of the post-conversion program are the same, are satisfied.

The conversion unit 613 converts the conversion target program into the post-conversion program under a necessary condition that it is determined that both the first condition and the second condition are satisfied.

The detection unit 611 is relevant to an example of a detection means. The determination unit 612 is relevant to an example of a determination means. The conversion unit 613 is relevant to an example of a conversion means.

According to the program conversion apparatus 610, it is possible to perform optimization of changing the execution order of processing for a program that handles data in a matrix format.

In particular, according to the program conversion apparatus 610, it is possible to determine whether optimization of changing the execution order of processing can be performed in a case where the conversion target program handles the matrix data to which the first direction partial data identification index is assigned. Then, in a case where it is determined that the optimization of changing the execution order of the processing can be performed, the program conversion apparatus 610 can execute the optimization. According to the program conversion apparatus 610, in this respect, it is possible to detect a relatively large number of cases where optimization of changing the execution order of processing can be performed for a program that handles data in a matrix format.

### Third Example Embodiment

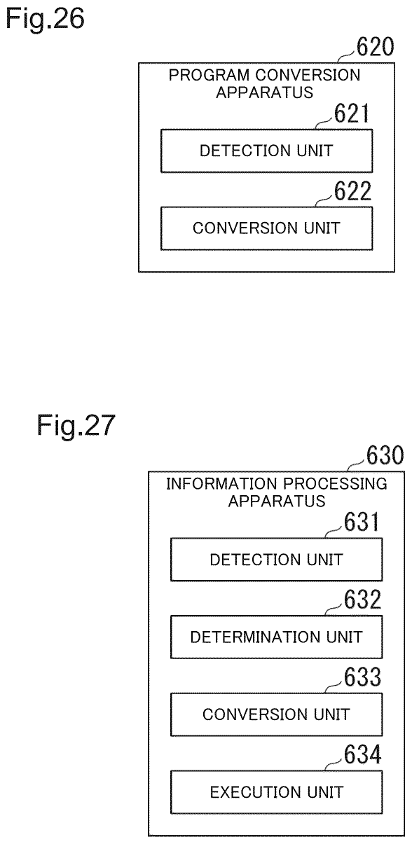

FIG. 26 is a diagram illustrating an example of a configuration of a program conversion apparatus according to at least one example embodiment. In the configuration illustrated in FIG. 26, a program conversion apparatus 620 includes a detection unit 621 and a conversion unit 622.

With such a configuration, the detection unit 621 detects matrix data including partial data in the second direction used for determining whether to delete individual pieces of partial data in the first direction in the second processing among the plurality of pieces of matrix data, with reference to the second direction partial data identification index for identifying the partial data in the second direction in each of the plurality of pieces of matrix data, for a conversion target program for performing the second processing of deleting the partial data in the first direction in the matrix data with respect to one piece of matrix data obtained in the first processing after performing the first processing of converting the plurality of pieces of matrix data into one piece of matrix data.

The conversion unit 622 converts the conversion target program into a post-conversion program that performs the first processing after performing the second processing on the detected matrix data.

The detection unit 621 is relevant to an example of a detection means. The conversion unit 622 is relevant to an example of a conversion means.

According to the program conversion apparatus 620, by rearranging the execution order of the first processing and the second processing so as to perform the second processing on the matrix data detected by the detection unit 621, it is possible to perform optimization of changing the execution order of processing for a program that handles data in a matrix format.

### Fourth Example Embodiment

FIG. 27 is a diagram illustrating an example of a configuration of an information processing apparatus according to at least one example embodiment.

In the configuration illustrated in FIG. 27, an information processing apparatus 630 includes a detection unit 631, a determination unit 632, a conversion unit 633, and an execution unit 634.

In such a configuration, the detection unit 631 converts a plurality of pieces of matrix data into one piece of matrix data, performs first processing of reassigning a first direction partial data identification index for identifying partial data in a first direction in the converted matrix data, and then detects matrix data including partial data in a second direction used for determining whether to delete individual pieces of partial data in the first direction in the second processing among the plurality of pieces of matrix data with respect to a conversion target program for performing second processing of deleting the partial data in the first direction with respect to one piece of matrix data obtained in the first processing.

The determination unit 632 determines whether both the first condition that the processing depending on the first direction partial data identification index is not included in the conversion target program or the first condition that the result of the processing depending on the first direction partial data identification index is the same in the conversion target program and the post-conversion program converted so as to perform the first processing after performing the second processing on the detected matrix data from the conversion target program, and the second condition that the first direction partial data identification index indicated in the execution result of the conversion target program and the first direction partial data identification index indicated in the execution result of the post-conversion program are the same, are satisfied.

The conversion unit 633 converts the conversion target program into the post-conversion program under a necessary condition that it is determined that both the first condition and the second condition are satisfied.

The execution unit 634 executes the post-conversion program.

The detection unit 631 is relevant to an example of a detection means. The determination unit 632 is relevant to an example of a determination means. The conversion unit 633 is relevant to an example of a conversion means. The execution unit 634 is relevant to an example of an execution means.

According to the information processing apparatus 630, it is possible to perform optimization of changing the execution order of processing for a program that handles data in a matrix format.

In particular, according to the information processing apparatus 630, it is possible to determine whether optimization of changing the execution order of processing can be performed in a case where the conversion target program handles the matrix data to which the first direction partial data identification index is assigned. Then, in a case where it is determined that the optimization of changing the execution order of the processing can be performed, the information processing apparatus 630 can execute the optimization. According to the information processing apparatus 630, in this respect, it is possible to detect a relatively large number of cases where optimization of changing the execution order of processing can be performed for a program that handles data in a matrix format.

### Fifth Example Embodiment

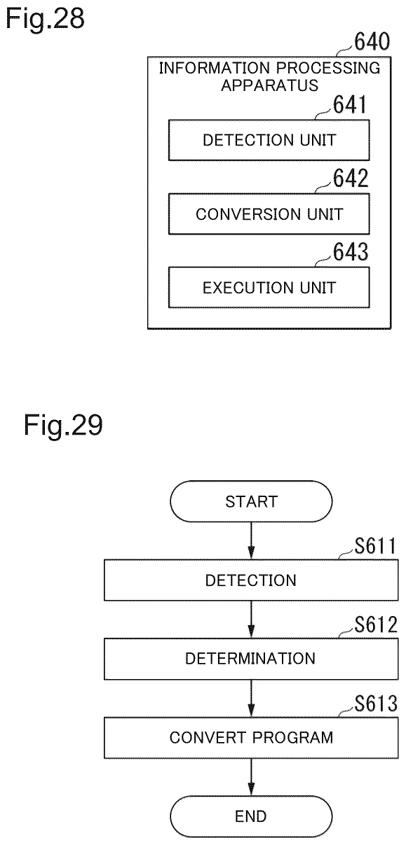

FIG. 28 is a diagram illustrating an example of a configuration of an information processing apparatus according to at least one example embodiment.

In the configuration illustrated in FIG. 28, an information processing apparatus 640 includes a detection unit 641, a conversion unit 642, and an execution unit 643.

With such a configuration, the detection unit 641 detects matrix data including partial data in the second direction used for determining whether to delete individual pieces of partial data in the first direction in the second processing among the plurality of pieces of matrix data, with reference to the second direction partial data identification index for identifying the partial data in the second direction in each of the plurality of pieces of matrix data, for a conversion target program for performing the second processing of deleting the partial data in the first direction in the matrix data with respect to one piece of matrix data obtained in the first processing after performing the first processing of converting the plurality of pieces of matrix data into one piece of matrix data.

The conversion unit 642 converts the conversion target program into a post-conversion program that performs the first processing after performing the second processing on the detected matrix data.

The execution unit 643 executes the post-conversion program.

The detection unit 641 is relevant to an example of a detection means. The conversion unit 642 is relevant to an example of a conversion means. The execution unit 643 is relevant to an example of an execution means.

According to the information processing apparatus 640, by rearranging the execution order of the first processing and the second processing so as to perform the second processing on the matrix data detected by the detection unit 641, it is possible to perform optimization of changing the execution order of processing for a program that handles data in a matrix format.

### Sixth Example Embodiment

FIG. 29 is a diagram illustrating an example of processing in the program conversion method according to at least one example embodiment. The program conversion method illustrated in FIG. 29 includes performing detection (step S611), performing determination (step S612), and converting a program (step S613).

In performing the detection (step S611), the computer converts a plurality of pieces of matrix data into one piece of matrix data, performs first processing of reassigning a first direction partial data identification index for identifying partial data in a first direction in the converted matrix data, and then detects matrix data including partial data in a second direction used for determining whether to delete individual pieces of partial data in the first direction in the second processing among the plurality of pieces of matrix data with respect to a conversion target program for performing second processing of deleting the partial data in the first direction with respect to one piece of matrix data obtained in the first processing.

In performing the determination (step S612), the computer determines whether both the first condition that the processing depending on the first direction partial data identification index is not included in the conversion target program or the first condition that the result of the processing depending on the first direction partial data identification index is the same in the conversion target program and the post-conversion program converted so as to perform the first processing after performing the second processing on the detected matrix data from the conversion target program, and the second condition that the first direction partial data identification index indicated in the execution result of the conversion target program and the first direction partial data identification index indicated in the execution result of the post-conversion program are the same, are satisfied.

In converting the program (step S613), the computer converts the conversion target program into the post-conversion program under a necessary condition that it is determined that both the first condition and the second condition are satisfied.

According to the program conversion method illustrated in FIG. 29, it is possible to perform optimization of changing the execution order of processing for a program that handles data in a matrix format.

In particular, according to the program conversion method illustrated in FIG. 29, it is possible to determine whether optimization of changing the execution order of processing can be performed in a case where the conversion target program handles the matrix data to which the first direction partial data identification index is assigned. Then, in a case where it is determined that the optimization of changing the execution order of the processing can be performed, the optimization can be executed by the program conversion method illustrated in FIG. 29. According to the program conversion method illustrated in FIG. 29, in this respect, it is possible to detect a relatively large number of cases where optimization of changing the execution order of processing can be performed for a program that handles data in a matrix format.

### Seventh Example Embodiment

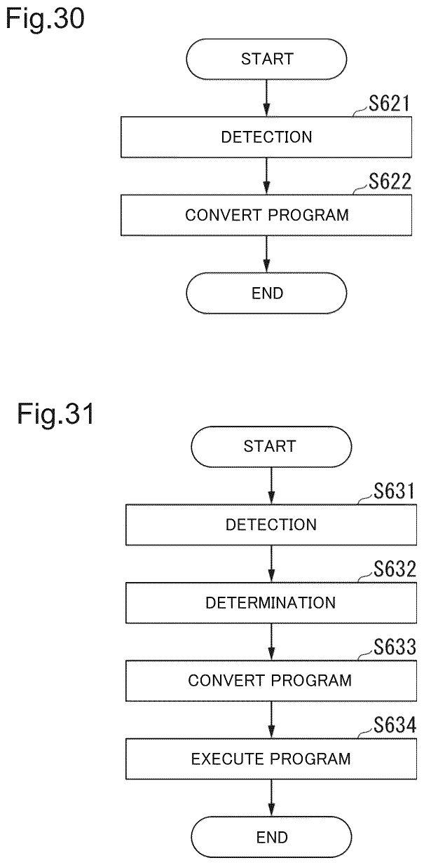

FIG. 30 is a diagram illustrating an example of processing in the program conversion method according to at least one example embodiment. The program conversion method illustrated in FIG. 30 includes performing detection (step S621) and converting a program (step S622).

In performing the detection (step S621), the computer detects matrix data including partial data in the second direction used for determining whether to delete individual pieces of partial data in the first direction in the second processing among the plurality of pieces of matrix data, with reference to the second direction partial data identification index for identifying the partial data in the second direction in each of the plurality of pieces of matrix data, for a conversion target program for performing the second processing of deleting the partial data in the first direction in the matrix data with respect to one piece of matrix data obtained in the first processing after performing the first processing of converting the plurality of pieces of matrix data into one piece of matrix data.

In converting the program (step S622), the computer converts the conversion target program into a post-conversion program that performs the first processing after performing the second processing on the detected matrix data.

According to the program conversion method illustrated in FIG. 30, by rearranging the execution order of the first processing and the second processing so as to perform the second processing on the detected matrix data, it is possible to perform optimization of changing the execution order of processing for a program that handles data in a matrix format.

### Eighth Example Embodiment

FIG. 31 is a diagram illustrating an example of processing in the information processing method according to at least one example embodiment. The information processing method illustrated in FIG. 31 includes performing detection (step S631), performing determination (step S632), converting a program (step S633), and executing the program (step S634).

In performing the detection (step S631), the computer converts a plurality of pieces of matrix data into one piece of matrix data, performs first processing of reassigning a first direction partial data identification index for identifying partial data in a first direction in the converted matrix data, and then detects matrix data including partial data in a second direction used for determining whether to delete individual pieces of partial data in the first direction in the second processing among the plurality of pieces of matrix data with respect to a conversion target program for performing second processing of deleting the partial data in the first direction with respect to one piece of matrix data obtained in the first processing.

In performing the determination (step S632), the computer determines whether both the first condition that the processing depending on the first direction partial data identification index is not included in the conversion target program or the first condition that the result of the processing depending on the first direction partial data identification index is the same in the conversion target program and the post-conversion program converted so as to perform the first processing after performing the second processing on the detected matrix data from the conversion target program, and the second condition that the first direction partial data identification index indicated in the execution result of the conversion target program and the first direction partial data identification index indicated in the execution result of the post-conversion program are the same, are satisfied.

In converting the program (step S633), the computer converts the conversion target program into the post-conversion program under a necessary condition that it is determined that both the first condition and the second condition are satisfied.

In executing the program (step S634), the computer executes the post-conversion program.

According to the information processing method illustrated in FIG. 31, it is possible to perform optimization of changing the execution order of processing for a program that handles data in a matrix format.

In particular, according to the information processing method illustrated in FIG. 31, it is possible to determine whether optimization of changing the execution order of processing can be performed in a case where the conversion target program handles the matrix data to which the first direction partial data identification index is assigned. Then, in a case where it is determined that the optimization of changing the execution order of the processing can be performed, the optimization can be executed by the information processing method illustrated in FIG. 31. According to the information processing method illustrated in FIG. 31, in this respect, it is possible to detect a relatively large number of cases where optimization of changing the execution order of processing can be performed for a program that handles data in a matrix format.

### Ninth Example Embodiment

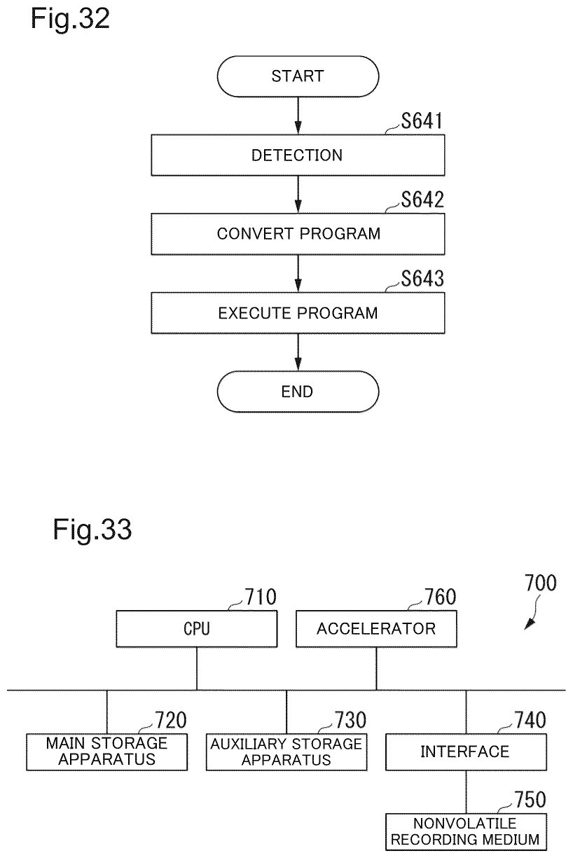

FIG. 32 is a diagram illustrating an example of processing in the information processing method according to at least one example embodiment. The information processing method illustrated in FIG. 32 includes performing detection (step S641), converting a program (step S642), and executing the program (step S643).

In performing the detection (step S641), the computer detects matrix data including partial data in the second direction used for determining whether to delete individual pieces of partial data in the first direction in the second processing among the plurality of pieces of matrix data, with reference to the second direction partial data identification index for identifying the partial data in the second direction in each of the plurality of pieces of matrix data, for a conversion target program for performing the second processing of deleting the partial data in the first direction in the matrix data with respect to one piece of matrix data obtained in the first processing after performing the first processing of converting the plurality of pieces of matrix data into one piece of matrix data.

In converting the program (step S642), the computer converts the conversion target program into a post-conversion program that performs the first processing after performing the second processing on the detected matrix data.

In executing the program (step S643), the computer executes the post-conversion program.

According to the information processing method illustrated in FIG. 32, by rearranging the execution order of the first processing and the second processing so as to perform the second processing on the detected matrix data, it is possible to perform optimization of changing the execution order of processing for a program that handles data in a matrix format.

FIG. 33 is a diagram illustrating an example of a configuration of a computer according to at least one example embodiment.

In the configuration illustrated in FIG. 33, a computer 700 includes a CPU 710, a main storage apparatus 720, an auxiliary storage apparatus 730, an interface 740, a nonvolatile recording medium 750, and an accelerator 760.

Any one or more of the information processing apparatus 100, the program conversion apparatus 610, the program conversion apparatus 620, the information processing apparatus 630, and the information processing apparatus 640 described above, or a part thereof, may be implemented in the computer 700. In this case, the operation of each processing unit described above is stored in the auxiliary storage apparatus 730 in the form of a program. The CPU 710 and the accelerator 760 read the program from the auxiliary storage apparatus 730, load the program in the main storage apparatus 720, and execute the above processing according to the program. The CPU 710 secures a storage area related to each of the above-described storage units in the main storage apparatus 720 according to the program. Communication between each apparatus and another apparatus is executed by the interface 740 having a communication function and performing communication under the control of the CPU 710. The interface 740 has a port for the nonvolatile recording medium 750, and reads information from the nonvolatile recording medium 750 and writes information to the nonvolatile recording medium 750.

In a case where the information processing apparatus 100 is implemented in the computer 700, the operation of the processing unit 190 and each unit thereof is stored in the auxiliary storage apparatus 730 in the form of a program. The CPU 710 and the accelerator 760 read the program from the auxiliary storage apparatus 730, load the program in the main storage apparatus 720, and execute the above processing according to the program.

The CPU 710 secures a storage area for the storage unit 180 in the main storage apparatus 720 according to the program. Communication with another apparatus by the communication unit 110 is executed by the interface 740 having a communication function and operating under control of the CPU 710. The display of the image by the display unit 120 is executed by the interface 740 including a display apparatus and displaying various images under the control of the CPU 710. The acceptance of user operation by the operation input unit 130 is executed by the interface 740 including an input device and accepting the user operation under the control of the CPU 710.

In a case where the program conversion apparatus 610 is implemented in the computer 700, the operations of the detection unit 611, the determination unit 612, and the conversion unit 613 are stored in the auxiliary storage apparatus 730 in the form of a program. The CPU 710 and the accelerator 760 read the program from the auxiliary storage apparatus 730, load the program in the main storage apparatus 720, and execute the above processing according to the program.

The CPU 710 secures a storage area for the program conversion apparatus 610 to perform processing in the main storage apparatus 720 according to the program. Communication between the program conversion apparatus 610 and another apparatus is executed by the interface 740 having a communication function and operating under the control of the CPU 710. The interaction between the program conversion apparatus 610 and the user is executed when the interface 740 includes an input device and an output device, information is presented to the user by the output device according to the control of the CPU 710, and a user operation is received by the input device.

In a case where the program conversion apparatus 620 is implemented in the computer 700, the operations of the detection unit 621 and the conversion unit 622 are stored in the auxiliary storage apparatus 730 in the form of a program. The CPU 710 and the accelerator 760 read the program from the auxiliary storage apparatus 730, load the program in the main storage apparatus 720, and execute the above processing according to the program.

The CPU 710 secures a storage area for the program conversion apparatus 620 to perform processing in the main storage apparatus 720 according to the program. Communication between the program conversion apparatus 620 and another apparatus is executed by the interface 740 having a communication function and operating under the control of the CPU 710. The interaction between the program conversion apparatus 620 and the user is executed when the interface 740 includes an input device and an output device, information is presented to the user by the output device according to the control of the CPU 710, and a user operation is received by the input device.

In a case where the information processing apparatus 630 is implemented in the computer 700, the operations of the detection unit 631, the determination unit 632, the conversion unit 633, and the execution unit 634 are stored in the auxiliary storage apparatus 730 in the form of a program. The CPU 710 and the accelerator 760 read the program from the auxiliary storage apparatus 730, load the program in the main storage apparatus 720, and execute the above processing according to the program.

The CPU 710 secures a storage area for the information processing apparatus 630 to perform processing in the main storage apparatus 720 according to the program. Communication between the information processing apparatus 630 and another apparatus is executed by the interface 740 having a communication function and operating under the control of the CPU 710. The interaction between the information processing apparatus 630 and the user is executed when the interface 740 includes an input device and an output device, information is presented to the user by the output device according to the control of the CPU 710, and a user operation is received by the input device.

In a case where the information processing apparatus 640 is implemented in the computer 700, the operations of the detection unit 641, the conversion unit 642, and the execution unit 643 are stored in the auxiliary storage apparatus 730 in the form of a program. The CPU 710 and the accelerator 760 read the program from the auxiliary storage apparatus 730, load the program in the main storage apparatus 720, and execute the above processing according to the program.

The CPU 710 secures a storage area for the information processing apparatus 640 to perform processing in the main storage apparatus 720 according to the program. Communication between the information processing apparatus 640 and another apparatus is executed by the interface 740 having a communication function and operating under the control of the CPU 710. The interaction between the information processing apparatus 640 and the user is executed when the interface 740 includes an input device and an output device, information is presented to the user by the output device according to the control of the CPU 710, and a user operation is received by the input device.

Any one or more of the above-described programs may be recorded in the nonvolatile recording medium 750. In this case, the interface 740 may read the program from the nonvolatile recording medium 750. The CPU 710 and the accelerator 760 may directly execute the program read by the interface 740, or may temporarily store the program in the main storage apparatus 720 or the auxiliary storage apparatus 730 and execute the program.

A program for executing all or part of the processing performed by the information processing apparatus 100, the program conversion apparatus 610, the program conversion apparatus 620, the information processing apparatus 630, and the information processing apparatus 640 may be recorded in a computer-readable recording medium, and the processing of each unit may be performed by causing a computer system to read and execute the program recorded in the recording medium. The “computer system” herein includes an operating system (OS) and hardware such as peripheral equipment.

The “computer-readable recording medium” refers to a portable medium such as a flexible disk, a magneto-optical disk, a read only memory (ROM), and a compact disc read only memory (CD-ROM), and a storage apparatus such as a hard disk built in a computer system. The program may be for implementing some of the functions described above, and the functions described above may be implemented in combination with a program already recorded in the computer system.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Some or all of the above example embodiments can also be described as the following Supplementary Notes, but are not limited to the following Supplementary Notes.

### (Supplementary Note 1)

A program conversion apparatus including:
a detection means for detecting matrix data including partial data in a second direction used for determining whether to delete individual pieces of partial data in a first direction in second processing among a plurality of pieces of matrix data, for a conversion target program for performing the second processing of deleting partial data in the first direction, with respect to one piece of matrix data obtained in first processing after performing the first processing of converting a plurality of pieces of matrix data into one piece of matrix data and reassigning a first direction partial data identification index for identifying partial data in the first direction in the converted matrix data;
a determination means for determining whether both a first condition that processing depending on the first direction partial data identification index is not included in the conversion target program or that a result of processing depending on the first direction partial data identification index is same between the conversion target program and post-conversion program converted to perform the first processing after performing the second processing on the matrix data detected from the conversion target program, and a second condition that the first direction partial data identification index indicated in an execution result of the conversion target program and the first direction partial data identification index indicated in an execution result of the post-conversion program are same, are satisfied; and
a conversion means for converting the conversion target program into the post-conversion program under a necessary condition that it is determined that both the first condition and the second condition are satisfied.

### (Supplementary Note 2)

The program conversion apparatus according to Supplementary Note 1, wherein
the determination means determines whether both a third condition that the second processing is performed without branching of processing after the first processing in the conversion target program and that reassignment of the first direction partial data identification index is performed in all processing paths after the first processing and the second processing are performed, and a fourth condition that processing depending on the first direction partial data identification index is not included between the second processing and the reassignment of the first direction partial data identification index in all the processing paths after the first processing and the second processing are performed, are satisfied, as determination of a sufficient condition as to whether both the first condition and the second condition are satisfied, and the conversion means converts the conversion target program into the post-conversion program that performs the first processing after performing the second processing on the matrix data detected, as a necessary condition that it is determined that both the third condition and the fourth condition are satisfied.

### (Supplementary Note 3)

The program conversion apparatus according to Supplementary Note 1 or Supplementary Note 2, wherein
the detection means refers to a second direction partial data identification index for identifying partial data in the second direction in each of the plurality of pieces of matrix data, and detects, among the plurality of pieces of matrix data, matrix data including partial data in the second direction used for determining whether to delete individual pieces of partial data in the first direction in the second processing.

### (Supplementary Note 4)

The program conversion apparatus according to Supplementary Note 3, wherein
the detection means refers to the second direction partial data identification index by referring to the plurality of pieces of matrix data input to the conversion target program.

### (Supplementary Note 5)

The program conversion apparatus according to Supplementary Note 3 or Supplementary Note 4, further including
an index processing means for acquiring the second direction partial data identification index in each of a plurality of pieces of matrix data to be subjected to the first processing by the post-conversion program by performing processing on matrix data in the conversion target program on the second direction partial data identification index in each of the
   plurality of pieces of matrix data, wherein
the detection means refers to the second direction partial data identification index in each of the plurality of pieces of matrix data to be subjected to the first processing in the post-conversion program, and detects, among the plurality of pieces of matrix data, matrix data including partial data in the second direction used for determining whether to delete individual pieces of partial data in the first direction in the second processing.

### (Supplementary Note 6)

The program conversion apparatus according to any one of Supplementary Notes 3 to 5, further including
a partial execution means for executing processing of reading data in the conversion target program to acquire information indicating the second direction partial data identification index in each of a plurality of pieces of matrix data to be subjected to the first processing.

### (Supplementary Note 7)

The program conversion apparatus according to any one of Supplementary Notes 3 to 5, further including
a partial execution means for executing processing of reading the second direction partial data identification index in the matrix data with respect to a command to read data in the conversion target program, and acquiring information indicating the second direction partial data identification index in each of a plurality of pieces of matrix data to be subjected to the first processing.

### (Supplementary Note 8)

A program conversion apparatus including:
a detection means for detecting matrix data including partial data in a second direction used for determining whether to delete individual pieces of partial data in a first direction in second processing among a plurality of pieces of matrix data, with reference to a second direction partial data identification index for identifying partial data in the second direction in each of the plurality of pieces of matrix data, for a conversion target program for performing the second processing of deleting partial data in the first direction in the matrix data, with respect to one piece of matrix data obtained in first processing after performing the first processing of converting a plurality of pieces of matrix data into one piece of matrix data; and
a conversion means for converting the conversion target program into a post-conversion program for performing the first processing after performing the second processing on the matrix data detected.

### (Supplementary Note 9)

The program conversion apparatus according to Supplementary Note 8, wherein
the detection means refers to the second direction partial data identification index by referring to the plurality of pieces of matrix data input to the conversion target program.

### (Supplementary Note 10)

The program conversion apparatus according to Supplementary Note 8 or Supplementary Note 9, further including
an index processing means for acquiring the second direction partial data identification index in each of a plurality of pieces of matrix data to be subjected to the first processing by the post-conversion program by performing processing on matrix data in the conversion target program on the second direction partial data identification index in each of the
   plurality of pieces of matrix data, wherein
the detection means refers to the second direction partial data identification index in each of the plurality of pieces of matrix data to be subjected to the first processing in the post-conversion program, and detects, among the plurality of pieces of matrix data, matrix data including partial data in the second direction used for determining whether to delete individual pieces of partial data in the first direction in the second processing.

### (Supplementary Note 11)

The program conversion apparatus according to any one of Supplementary Notes 8 to 10, further including
a partial execution means for executing processing of reading data in the conversion target program to acquire information indicating the second direction partial data identification index in each of a plurality of pieces of matrix data to be subjected to the first processing.

### (Supplementary Note 12)

The program conversion apparatus according to any one of Supplementary Notes 8 to 10, further including
a partial execution means for executing processing of reading the second direction partial data identification index in the matrix data with respect to a command to read data in the conversion target program, and acquiring information indicating the second direction partial data identification index in each of a plurality of pieces of matrix data to be subjected to the first processing.

### (Supplementary Note 13)

An information processing apparatus including:
a detection means for detecting matrix data including partial data in a second direction used for determining whether to delete individual pieces of partial data in a first direction in second processing among a plurality of pieces of matrix data, for a conversion target program for performing the second processing of deleting partial data in the first direction, with respect to one piece of matrix data obtained in first processing after performing the first processing of converting a plurality of pieces of matrix data into one piece of matrix data and reassigning a first direction partial data identification index for identifying partial data in the first direction in the converted matrix data;
a determination means for determining whether both a first condition that processing depending on the first direction partial data identification index is not included in the conversion target program or that a result of processing depending on the first direction partial data identification index is same between the conversion target program and post-conversion program converted to perform the first processing after performing the second processing on the matrix data detected from the conversion target program, and a second condition that the first direction partial data identification index indicated in an execution result of the conversion target program and the first direction partial data identification index indicated in an execution result of the post-conversion program are same, are satisfied;
a conversion means for converting the conversion target program into the post-conversion program under a necessary condition that it is determined that both the first condition and the second condition are satisfied; and
an execution means for executing the post-conversion program.

### (Supplementary Note 14)

The information processing apparatus according to Supplementary Note 13, wherein
the determination means determines whether both a third condition that the second processing is performed without branching of processing after the first processing in the conversion target program and that reassignment of the first direction partial data identification index is performed in all processing paths after the first processing and the second processing are performed, and a fourth condition that processing depending on the first direction partial data identification index is not included between the second processing and the reassignment of the first direction partial data identification index in all the processing paths after the first processing and the second processing are performed, are satisfied, as determination of a sufficient condition as to whether both the first condition and the second condition are satisfied, and
the conversion means converts the conversion target program into the post-conversion program that performs the first processing after performing the second processing on the matrix data detected, as a necessary condition that it is determined that both the third condition and the fourth condition are satisfied.

### (Supplementary Note 15)

The information processing apparatus according to Supplementary Note 13 or Supplementary Note 14, wherein
the detection means refers to a second direction partial data identification index for identifying partial data in the second direction in each of the plurality of pieces of matrix data, and detects, among the plurality of pieces of matrix data, matrix data including partial data in the second direction used for determining whether to delete individual pieces of partial data in the first direction in the second processing.

### (Supplementary Note 16)

The information processing apparatus according to Supplementary Note 15, wherein
the detection means refers to the second direction partial data identification index by referring to the plurality of pieces of matrix data input to the conversion target program.

### (Supplementary Note 17)

The information processing apparatus according to Supplementary Note 15 or Supplementary Note 16, further including
an index processing means for acquiring the second direction partial data identification index in each of a plurality of pieces of matrix data to be subjected to the first processing by the post-conversion program by performing processing on matrix data in the conversion target program on the second direction partial data identification index in each of the
   plurality of pieces of matrix data, wherein
the detection means refers to the second direction partial data identification index in each of the plurality of pieces of matrix data to be subjected to the first processing in the post-conversion program, and detects, among the plurality of pieces of matrix data, matrix data including partial data in the second direction used for determining whether to delete individual pieces of partial data in the first direction in the second processing.

### (Supplementary Note 18)

The information processing apparatus according to any one of Supplementary Notes 15 to 17, further including
a partial execution means for executing processing of reading data in the conversion target program to acquire information indicating the second direction partial data identification index in each of a plurality of pieces of matrix data to be subjected to the first processing.

### (Supplementary Note 19)

The information processing apparatus according to any one of Supplementary Notes 15 to 17, further including
a partial execution means for executing processing of reading the second direction partial data identification index in the matrix data with respect to a command to read data in the conversion target program, and acquiring information indicating the second direction partial data identification index in each of a plurality of pieces of matrix data to be subjected to the first processing.

### (Supplementary Note 20)

An information processing apparatus including:
a detection means for detecting matrix data including partial data in a second direction used for determining whether to delete individual pieces of partial data in a first direction in second processing among a plurality of pieces of matrix data, with reference to a second direction partial data identification index for identifying partial data in the second direction in each of the plurality of pieces of matrix data, for a conversion target program for performing the second processing of deleting partial data in the first direction in the matrix data, with respect to one piece of matrix data obtained in first processing after performing the first processing of converting a plurality of pieces of matrix data into one piece of matrix data;
a conversion means for converting the conversion target program into a post-conversion program for performing the first processing after performing the second processing on the matrix data detected; and
an execution means for executing the post-conversion program.

### (Supplementary Note 21)

The information processing apparatus according to Supplementary Note 20, wherein
the detection means refers to the second direction partial data identification index by referring to the plurality of pieces of matrix data input to the conversion target program.

### (Supplementary Note 22)

The information processing apparatus according to Supplementary Note 20 or Supplementary Note 21, further including
an index processing means for acquiring the second direction partial data identification index in each of a plurality of pieces of matrix data to be subjected to the first processing by the post-conversion program by performing processing on matrix data in the conversion target program on the second direction partial data identification index in each of the
   plurality of pieces of matrix data, wherein
the detection means refers to the second direction partial data identification index in each of the plurality of pieces of matrix data to be subjected to the first processing in the post-conversion program, and detects, among the plurality of pieces of matrix data, matrix data including partial data in the second direction used for determining whether to delete individual pieces of partial data in the first direction in the second processing.

### (Supplementary Note 23)

The information processing apparatus according to any one of Supplementary Notes 20 to 22, further including
a partial execution means for executing processing of reading data in the conversion target program to acquire information indicating the second direction partial data identification index in each of a plurality of pieces of matrix data to be subjected to the first processing.

### (Supplementary Note 24)

The information processing apparatus according to any one of Supplementary Notes 20 to 23, further including
a partial execution means for executing processing of reading the second direction partial data identification index in the matrix data with respect to a command to read data in the conversion target program, and acquiring information indicating the second direction partial data identification index in each of a plurality of pieces of matrix data to be subjected to the first processing.

### (Supplementary Note 25)

A program conversion method including, by a computer:
detecting matrix data including partial data in a second direction used for determining whether to delete individual pieces of partial data in a first direction in second processing among a plurality of pieces of matrix data, for a conversion target program for performing the second processing of deleting partial data in the first direction, with respect to one piece of matrix data obtained in first processing after performing the first processing of converting a plurality of pieces of matrix data into one piece of matrix data and reassigning a first direction partial data identification index for identifying partial data in the first direction in the converted matrix data;
determining whether both a first condition that processing depending on the first direction partial data identification index is not included in the conversion target program or that a result of processing depending on the first direction partial data identification index is same between the conversion target program and post-conversion program converted to perform the first processing after performing the second processing on the matrix data detected from the conversion target program, and a second condition that the first direction partial data identification index indicated in an execution result of the conversion target program and the first direction partial data identification index indicated in an execution result of the post-conversion program are same, are satisfied; and
converting the conversion target program into the post-conversion program under a necessary condition that it is determined that both the first condition and the second condition are satisfied.

### (Supplementary Note 26)

The program conversion method according to Supplementary Note 25, wherein
the determining includes determining, by the computer, whether both a third condition that the second processing is performed without branching of processing after the first processing in the conversion target program and that reassignment of the first direction partial data identification index is performed in all processing paths after the first processing and the second processing are performed, and a fourth condition that processing depending on the first direction partial data identification index is not included between the second processing and the reassignment of the first direction partial data identification index in all the processing paths after the first processing and the second processing are performed, are satisfied, as determination of a sufficient condition as to whether both the first condition and the second condition are satisfied, and
the converting includes converting, by the computer, the conversion target program into the post-conversion program that performs the first processing after performing the second processing on the matrix data detected, as a necessary condition that it is determined that both the third condition and the fourth condition are satisfied.

### (Supplementary Note 27)

The program conversion method according to Supplementary Note 25 or Supplementary Note 26, wherein
the detecting includes referring to, by the computer, a second direction partial data identification index for identifying partial data in the second direction in each of the plurality of pieces of matrix data, and detecting, among the plurality of pieces of matrix data, matrix data including partial data in the second direction used for determining whether to delete individual pieces of partial data in the first direction in the second processing.

### (Supplementary Note 28)

The program conversion method according to Supplementary Note 27, wherein
the detecting includes referring to, by the computer, the second direction partial data identification index by referring to the plurality of pieces of matrix data input to the conversion target program.

### (Supplementary Note 29)

The program conversion method according to Supplementary Note 27 or Supplementary Note 28, further including
acquiring, by the computer, the second direction partial data identification index in each of a plurality of pieces of matrix data to be subjected to the first processing by the post-conversion program by performing processing on matrix data in the conversion target program on the second direction partial data identification index in each of the plurality of pieces of matrix data, wherein
the detecting includes referring to, by the computer, the second direction partial data identification index in each of the plurality of pieces of matrix data to be subjected to the first processing in the post-conversion program, and detecting, among the plurality of pieces of matrix data, matrix data including partial data in the second direction used for determining whether to delete individual pieces of partial data in the first direction in the second processing.

### (Supplementary Note 30)

The program conversion method according to any one of Supplementary Notes 27 to 29, further including
executing, by the computer, processing of reading data in the conversion target program to acquire information indicating the second direction partial data identification index in each of a plurality of pieces of matrix data to be subjected to the first processing.

### (Supplementary Note 31)

The program conversion method according to any one of Supplementary Notes 27 to 29, further including
executing, by the computer, processing of reading the second direction partial data identification index in the matrix data with respect to a command to read data in the conversion target program, and acquiring information indicating the second direction partial data identification index in each of a plurality of pieces of matrix data to be subjected to the first processing.

### (Supplementary Note 32)

A program conversion method including, by a computer:
detecting matrix data including partial data in a second direction used for determining whether to delete individual pieces of partial data in a first direction in second processing among a plurality of pieces of matrix data, with reference to a second direction partial data identification index for identifying partial data in the second direction in each of the plurality of pieces of matrix data, for a conversion target program for performing the second processing of deleting partial data in the first direction in the matrix data, with respect to one piece of matrix data obtained in first processing after performing the first processing of converting a plurality of pieces of matrix data into one piece of matrix data; and
converting the conversion target program into a post-conversion program for performing the first processing after performing the second processing on the matrix data detected.

### (Supplementary Note 33)

The program conversion method according to Supplementary Note 32, wherein
the detecting includes referring to, by the computer, the second direction partial data identification index by referring to the plurality of pieces of matrix data input to the conversion target program.

### (Supplementary Note 34)

The program conversion method according to Supplementary Note 32 or Supplementary Note 33, further including
acquiring, by the computer, the second direction partial data identification index in each of a plurality of pieces of matrix data to be subjected to the first processing by the post-conversion program by performing processing on matrix data in the conversion target program on the second direction partial data identification index in each of the plurality of pieces of matrix data, wherein
the detecting includes referring to, by the computer, the second direction partial data identification index in each of the plurality of pieces of matrix data to be subjected to the first processing in the post-conversion program, and detecting, among the plurality of pieces of matrix data, matrix data including partial data in the second direction used for determining whether to delete individual pieces of partial data in the first direction in the second processing.

### (Supplementary Note 35)

The program conversion method according to any one of Supplementary Notes 32 to 34, further including
executing, by the computer, processing of reading data in the conversion target program to acquire information indicating the second direction partial data identification index in each of a plurality of pieces of matrix data to be subjected to the first processing.

### (Supplementary Note 36)

The program conversion method according to any one of Supplementary Notes 32 to 34, further including
executing, by the computer, processing of reading the second direction partial data identification index in the matrix data with respect to a command to read data in the conversion target program, and acquiring information indicating the second direction partial data identification index in each of a plurality of pieces of matrix data to be subjected to the first processing.

### (supplementary Note 37)

An information processing method including,
by a computer:
detecting matrix data including partial data in a second direction used for determining whether to delete individual pieces of partial data in a first direction in second processing among a plurality of pieces of matrix data, for a conversion target program for performing the second processing of deleting partial data in the first direction, with respect to one piece of matrix data obtained in first processing after performing the first processing of converting a plurality of pieces of matrix data into one piece of matrix data and reassigning a first direction partial data identification index for identifying partial data in the first direction in the converted matrix data;
determining whether both a first condition that processing depending on the first direction partial data identification index is not included in the conversion target program or that a result of processing depending on the first direction partial data identification index is same between the conversion target program and post-conversion program converted to perform the first processing after performing the second processing on the matrix data detected from the conversion target program, and a second condition that the first direction partial data identification index indicated in an execution result of the conversion target program and the first direction partial data identification index indicated in an execution result of the post-conversion program are same, are satisfied;
converting the conversion target program into the post-conversion program under a necessary condition that it is determined that both the first condition and the second condition are satisfied; and
executing the post-conversion program.

### (Supplementary Note 38)

The information processing method according to Supplementary Note 37, wherein
the determining includes determining, by the computer, whether both a third condition that the second processing is performed without branching of processing after the first processing in the conversion target program and that reassignment of the first direction partial data identification index is performed in all processing paths after the first processing and the second processing are performed, and a fourth condition that processing depending on the first direction partial data identification index is not included between the second processing and the reassignment of the first direction partial data identification index in all the processing paths after the first processing and the second processing are performed, are satisfied, as determination of a sufficient condition as to whether both the first condition and the second condition are satisfied, and
the converting includes converting, by the computer, the conversion target program into the post-conversion program that performs the first processing after performing the second processing on the matrix data detected, as a necessary condition that it is determined that both the third condition and the fourth condition are satisfied.

### (Supplementary Note 39)

The information processing method according to Supplementary Note 37 or Supplementary Note 38, wherein
the detecting includes referring to, by the computer, a second direction partial data identification index for identifying partial data in the second direction in each of the plurality of pieces of matrix data, and detecting, among the plurality of pieces of matrix data, matrix data including partial data in the second direction used for determining whether to delete individual pieces of partial data in the first direction in the second processing.

### (Supplementary Note 40)

The information processing method according to Supplementary Note 39, wherein
the detecting includes referring to, by the computer, the second direction partial data identification index by referring to the plurality of pieces of matrix data input to the conversion target program.

### (Supplementary Note 41)

The information processing method according to Supplementary Note 39 or Supplementary Note 40, further including
acquiring, by the computer, the second direction partial data identification index in each of a plurality of pieces of matrix data to be subjected to the first processing by the post-conversion program by performing processing on matrix data in the conversion target program on the second direction partial data identification index in each of the plurality of pieces of matrix data, wherein
the detecting includes referring to, by the computer, the second direction partial data identification index in each of the plurality of pieces of matrix data to be subjected to the first processing in the post-conversion program, and detecting, among the plurality of pieces of matrix data, matrix data including partial data in the second direction used for determining whether to delete individual pieces of partial data in the first direction in the second processing.

### (Supplementary Note 42)

The information processing method according to any one of Supplementary Notes 39 to 41, further including
executing, by the computer, processing of reading data in the conversion target program to acquire information indicating the second direction partial data identification index in each of a plurality of pieces of matrix data to be subjected to the first processing.

### (Supplementary Note 43)

The information processing method according to any one of Supplementary Notes 39 to 41, further including
executing, by the computer, processing of reading the second direction partial data identification index in the matrix data with respect to a command to read data in the conversion target program, and acquiring information indicating the second direction partial data identification index in each of a plurality of pieces of matrix data to be subjected to the first processing.

### (Supplementary Note 44)

An information processing method including,
by a computer:
detecting matrix data including partial data in a second direction used for determining whether to delete individual pieces of partial data in a first direction in second processing among a plurality of pieces of matrix data, with reference to a second direction partial data identification index for identifying partial data in the second direction in each of the plurality of pieces of matrix data, for a conversion target program for performing the second processing of deleting partial data in the first direction in the matrix data, with respect to one piece of matrix data obtained in first processing after performing the first processing of converting a plurality of pieces of matrix data into one piece of matrix data;
converting the conversion target program into a post-conversion program for performing the first processing after performing the second processing on the matrix data detected; and
executing the post-conversion program.

### (Supplementary Note 45)

The information processing method according to Supplementary Note 44, wherein
the detecting includes referring to, by the computer, the second direction partial data identification index by referring to the plurality of pieces of matrix data input to the conversion target program.

### (Supplementary Note 46)

The information processing method according to Supplementary Note 44 or Supplementary Note 45, further including
acquiring, by the computer, the second direction partial data identification index in each of a plurality of pieces of matrix data to be subjected to the first processing by the post-conversion program by performing processing on matrix data in the conversion target program on the second direction partial data identification index in each of the plurality of pieces of matrix data, wherein
the detecting includes referring to, by the computer, the second direction partial data identification index in each of the plurality of pieces of matrix data to be subjected to the first processing in the post-conversion program, and detecting, among the plurality of pieces of matrix data, matrix data including partial data in the second direction used for determining whether to delete individual pieces of partial data in the first direction in the second processing.

### (Supplementary Note 47)

The information processing method according to any one of Supplementary Notes 44 to 46, further including
executing, by the computer, processing of reading data in the conversion target program to acquire information indicating the second direction partial data identification index in each of a plurality of pieces of matrix data to be subjected to the first processing.

### (Supplementary Note 48)

The information processing method according to any one of Supplementary Notes 44 to 46, further including
executing, by the computer, processing of reading the second direction partial data identification index in the matrix data with respect to a command to read data in the conversion target program, and acquiring information indicating the second direction partial data identification index in each of a plurality of pieces of matrix data to be subjected to the first processing.

### (Supplementary Note 49)

A program causing
a computer to perform:
detecting matrix data including partial data in a second direction used for determining whether to delete individual pieces of partial data in a first direction in second processing among a plurality of pieces of matrix data, for a conversion target program for performing the second processing of deleting partial data in the first direction, with respect to one piece of matrix data obtained in first processing after performing the first processing of converting a plurality of pieces of matrix data into one piece of matrix data and reassigning a first direction partial data identification index for identifying partial data in the first direction in the converted matrix data;
determining whether both a first condition that processing depending on the first direction partial data identification index is not included in the conversion target program or that a result of processing depending on the first direction partial data identification index is same between the conversion target program and post-conversion program converted to perform the first processing after performing the second processing on the matrix data detected from the conversion target program, and a second condition that the first direction partial data identification index indicated in an execution result of the conversion target program and the first direction partial data identification index indicated in an execution result of the post-conversion program are same, are satisfied; and
converting the conversion target program into the post-conversion program under a necessary condition that it is determined that both the first condition and the second condition are satisfied.

### (Supplementary Note 50)

The program according to Supplementary Note 49, wherein
the determining includes causing the computer to determine whether both a third condition that the second processing is performed without branching of processing after the first processing in the conversion target program and that reassignment of the first direction partial data identification index is performed in all processing paths after the first processing and the second processing are performed, and a fourth condition that processing depending on the first direction partial data identification index is not included between the second processing and the reassignment of the first direction partial data identification index in all the processing paths after the first processing and the second processing are performed, are satisfied, as determination of a sufficient condition as to whether both the first condition and the second condition are satisfied, and
the converting includes causing the computer to convert the conversion target program into the post-conversion program that performs the first processing after performing the second processing on the matrix data detected, as a necessary condition that it is determined that both the third condition and the fourth condition are satisfied.

### (Supplementary Note 51)

The program according to Supplementary Note 49 or Supplementary Note 50, wherein
the detecting includes causing the computer to refer to a second direction partial data identification index for identifying partial data in the second direction in each of the plurality of pieces of matrix data, and detect, among the plurality of pieces of matrix data, matrix data including partial data in the second direction used for determining whether to delete individual pieces of partial data in the first direction in the second processing.

### (Supplementary Note 52)

The program according to Supplementary Note 51, wherein
the detecting includes causing the computer to refer to the second direction partial data identification index by referring to the plurality of pieces of matrix data input to the conversion target program.

### (Supplementary Note 53)

The program according to Supplementary Note 51 or Supplementary Note 52, further including
causing the computer to acquire the second direction partial data identification index in each of a plurality of pieces of matrix data to be subjected to the first processing by the post-conversion program by performing processing on matrix data in the conversion target program on the second direction partial data identification index in each of the plurality of pieces of matrix data, wherein
the detecting includes causing the computer to refer to the second direction partial data identification index in each of the plurality of pieces of matrix data to be subjected to the first processing in the post-conversion program, and detect, among the plurality of pieces of matrix data, matrix data including partial data in the second direction used for determining whether to delete individual pieces of partial data in the first direction in the second processing.

### (Supplementary Note 54)

The program according to any one of Supplementary Notes 51 to 53, further including
causing the computer to execute processing of reading data in the conversion target program to acquire information indicating the second direction partial data identification index in each of a plurality of pieces of matrix data to be subjected to the first processing.

### (Supplementary Note 55)

The program according to any one of Supplementary Notes 51 to 53, further including
causing the computer to execute processing of reading the second direction partial data identification index in the matrix data with respect to a command to read data in the conversion target program, and acquiring information indicating the second direction partial data identification index in each of a plurality of pieces of matrix data to be subjected to the first processing.

### (Supplementary Note 56)

A program causing
a computer to perform:
detecting matrix data including partial data in a second direction used for determining whether to delete individual pieces of partial data in a first direction in second processing among a plurality of pieces of matrix data, with reference to a second direction partial data identification index for identifying partial data in the second direction in each of the plurality of pieces of matrix data, for a conversion target program for performing the second processing of deleting partial data in the first direction in the matrix data, with respect to one piece of matrix data obtained in first processing after performing the first processing of converting a plurality of pieces of matrix data into one piece of matrix data; and
converting the conversion target program into a post-conversion program for performing the first processing after performing the second processing on the matrix data detected.

### (Supplementary Note 57)

The program according to Supplementary Note 56, wherein
the detecting includes causing the computer to refer to the second direction partial data identification index by referring to the plurality of pieces of matrix data input to the conversion target program.

### (Supplementary Note 58)

The program according to Supplementary Note 56 or Supplementary Note 57, further including
causing the computer to acquire the second direction partial data identification index in each of a plurality of pieces of matrix data to be subjected to the first processing by the post-conversion program by performing processing on matrix data in the conversion target program on the second direction partial data identification index in each of the plurality of pieces of matrix data, wherein
the detecting includes causing the computer to refer to the second direction partial data identification index in each of the plurality of pieces of matrix data to be subjected to the first processing in the post-conversion program, and detect, among the plurality of pieces of matrix data, matrix data including partial data in the second direction used for determining whether to delete individual pieces of partial data in the first direction in the second processing.

### (Supplementary Note 59)

The program according to any one of Supplementary Notes 56 to 58, further including
causing the computer to execute processing of reading data in the conversion target program to acquire information indicating the second direction partial data identification index in each of a plurality of pieces of matrix data to be subjected to the first processing.

### (Supplementary Note 60)

The program according to any one of Supplementary Notes 56 to 58, further including
causing the computer to execute processing of reading the second direction partial data identification index in the matrix data with respect to a command to read data in the conversion target program, and acquiring information indicating the second direction partial data identification index in each of a plurality of pieces of matrix data to be subjected to the first processing.

### (Supplementary Note 61)

A program causing
a computer to perform:
detecting matrix data including partial data in a second direction used for determining whether to delete individual pieces of partial data in a first direction in second processing among a plurality of pieces of matrix data, for a conversion target program for performing the second processing of deleting partial data in the first direction, with respect to one piece of matrix data obtained in first processing after performing the first processing of converting a plurality of pieces of matrix data into one piece of matrix data and reassigning a first direction partial data identification index for identifying partial data in the first direction in the converted matrix data;
determining whether both a first condition that processing depending on the first direction partial data identification index is not included in the conversion target program or that a result of processing depending on the first direction partial data identification index is same between the conversion target program and post-conversion program converted to perform the first processing after performing the second processing on the matrix data detected from the conversion target program, and a second condition that the first direction partial data identification index indicated in an execution result of the conversion target program and the first direction partial data identification index indicated in an execution result of the post-conversion program are same, are satisfied;
converting the conversion target program into the post-conversion program under a necessary condition that it is determined that both the first condition and the second condition are satisfied; and
executing the post-conversion program.

### (Supplementary Note 62)

The program according to Supplementary Note 61, wherein
the determining includes causing the computer to determine whether both a third condition that the second processing is performed without branching of processing after the first processing in the conversion target program and that reassignment of the first direction partial data identification index is performed in all processing paths after the first processing and the second processing are performed, and a fourth condition that processing depending on the first direction partial data identification index is not included between the second processing and the reassignment of the first direction partial data identification index in all the processing paths after the first processing and the second processing are performed, are satisfied, as determination of a sufficient condition as to whether both the first condition and the second condition are satisfied, and
the converting includes causing the computer to convert the conversion target program into the post-conversion program that performs the first processing after performing the second processing on the matrix data detected, as a necessary condition that it is determined that both the third condition and the fourth condition are satisfied.

### (Supplementary Note 63)

The program according to Supplementary Note 61 or Supplementary Note 62, wherein
the detecting includes causing the computer to refer to a second direction partial data identification index for identifying partial data in the second direction in each of the plurality of pieces of matrix data, and detect, among the plurality of pieces of matrix data, matrix data including partial data in the second direction used for determining whether to delete individual pieces of partial data in the first direction in the second processing.

### (Supplementary Note 64)

The program according to Supplementary Note 63, wherein
the detecting includes causing the computer to refer to the second direction partial data identification index by referring to the plurality of pieces of matrix data input to the conversion target program.

### (Supplementary Note 65)

The program according to Supplementary Note 63 or Supplementary Note 64, further including
causing the computer to acquire the second direction partial data identification index in each of a plurality of pieces of matrix data to be subjected to the first processing by the post-conversion program by performing processing on matrix data in the conversion target program on the second direction partial data identification index in each of the plurality of pieces of matrix data, wherein
the detecting includes causing the computer to refer to the second direction partial data identification index in each of the plurality of pieces of matrix data to be subjected to the first processing in the post-conversion program, and detect, among the plurality of pieces of matrix data, matrix data including partial data in the second direction used for determining whether to delete individual pieces of partial data in the first direction in the second processing.

### (Supplementary Note 66)

The program according to any one of Supplementary Notes 63 to 65, further including
causing the computer to execute processing of reading data in the conversion target program to acquire information indicating the second direction partial data identification index in each of a plurality of pieces of matrix data to be subjected to the first processing.

### (Supplementary Note 67)

The program according to any one of Supplementary Notes 63 to 65, further including
causing the computer to execute processing of reading the second direction partial data identification index in the matrix data with respect to a command to read data in the conversion target program, and acquiring information indicating the second direction partial data identification index in each of a plurality of pieces of matrix data to be subjected to the first processing.

### (Supplementary Note 68)

A program causing
a computer to perform:
detecting matrix data including partial data in a second direction used for determining whether to delete individual pieces of partial data in a first direction in second processing among a plurality of pieces of matrix data, with reference to a second direction partial data identification index for identifying partial data in the second direction in each of the plurality of pieces of matrix data, for a conversion target program for performing the second processing of deleting partial data in the first direction in the matrix data, with respect to one piece of matrix data obtained in first processing after performing the first processing of converting a plurality of pieces of matrix data into one piece of matrix data;
converting the conversion target program into a post-conversion program for performing the first processing after performing the second processing on the matrix data detected; and
executing the post-conversion program.

### (Supplementary Note 69)

The program according to Supplementary Note 68, wherein
the detecting includes causing the computer to refer to the second direction partial data identification index by referring to the plurality of pieces of matrix data input to the conversion target program.

### (Supplementary Note 70)

The program according to Supplementary Note 68 or Supplementary Note 69, further including
causing the computer to acquire the second direction partial data identification index in each of a plurality of pieces of matrix data to be subjected to the first processing by the post-conversion program by performing processing on matrix data in the conversion target program on the second direction partial data identification index in each of the plurality of pieces of matrix data, wherein
the detecting includes causing the computer to refer to the second direction partial data identification index in each of the plurality of pieces of matrix data to be subjected to the first processing in the post-conversion program, and detect, among the plurality of pieces of matrix data, matrix data including partial data in the second direction used for determining whether to delete individual pieces of partial data in the first direction in the second processing.

### (Supplementary Note 71)

The program according to any one of Supplementary Notes 68 to 70, further including
causing the computer to execute processing of reading data in the conversion target program to acquire information indicating the second direction partial data identification index in each of a plurality of pieces of matrix data to be subjected to the first processing.

### (Supplementary Note 72)

The program according to any one of Supplementary Notes 68 to 70, further including
causing the computer to execute processing of reading the second direction partial data identification index in the matrix data with respect to a command to read data in the conversion target program, and acquiring information indicating the second direction partial data identification index in each of a plurality of pieces of matrix data to be subjected to the first processing.

1. A program conversion apparatus comprising:
a detector configured to detect matrix data including partial data in a second direction used for determining whether to delete individual pieces of partial data in a first direction in second processing among a plurality of pieces of matrix data, for a conversion target program for performing the second processing of deleting partial data in the first direction, with respect to one piece of matrix data obtained in first processing after performing the first processing of converting a plurality of pieces of matrix data into one piece of matrix data and reassigning a first direction partial data identification index for identifying partial data in the first direction in the converted matrix data;
a determiner configured to determine whether both a first condition that processing depending on the first direction partial data identification index is not included in the conversion target program or that a result of processing depending on the first direction partial data identification index is same between the conversion target program and post-conversion program converted to perform the first processing after performing the second processing on the matrix data detected from the conversion target program, and a second condition that the first direction partial data identification index indicated in an execution result of the conversion target program and the first direction partial data identification index indicated in an execution result of the post-conversion program are same, are satisfied; and
a converter configured to convert the conversion target program into the post-conversion program under a necessary condition that it is determined that both the first condition and the second condition are satisfied.

2. The program conversion apparatus according to claim 1, wherein
the determiner determines whether both a third condition that the second processing is performed without branching of processing after the first processing in the conversion target program and that reassignment of the first direction partial data identification index is performed in all processing paths after the first processing and the second processing are performed, and a fourth condition that processing depending on the first direction partial data identification index is not included between the second processing and the reassignment of the first direction partial data identification index in all the processing paths after the first processing and the second processing are performed, are satisfied, as determination of a sufficient condition as to whether both the first condition and the second condition are satisfied, and
the converter converts the conversion target program into the post-conversion program that performs the first processing after performing the second processing on the matrix data detected, as a necessary condition that it is determined that both the third condition and the fourth condition are satisfied.

3. The program conversion apparatus according to claim 1, wherein
the detector refers to a second direction partial data identification index for identifying partial data in the second direction in each of the plurality of pieces of matrix data, and detects, among the plurality of pieces of matrix data, matrix data including partial data in the second direction used for determining whether to delete individual pieces of partial data in the first direction in the second processing.

4. The program conversion apparatus according to claim 3, wherein
the detector refers to the second direction partial data identification index by referring to the plurality of pieces of matrix data input to the conversion target program.

5. The program conversion apparatus according to claim 3, further comprising
an index processor configured to acquire the second direction partial data identification index in each of a plurality of pieces of matrix data to be subjected to the first processing by the post-conversion program by performing processing on matrix data in the conversion target program on the second direction partial data identification index in each of the
plurality of pieces of matrix data, wherein
the detector refers to the second direction partial data identification index in each of the plurality of pieces of matrix data to be subjected to the first processing in the post-conversion program, and detects, among the plurality of pieces of matrix data, matrix data including partial data in the second direction used for determining whether to delete individual pieces of partial data in the first direction in the second processing.

6. The program conversion apparatus according to claim 3, further comprising
a partial executor configured to execute processing of reading data in the conversion target program to acquire information indicating the second direction partial data identification index in each of a plurality of pieces of matrix data to be subjected to the first processing.

7. The program conversion apparatus according to claim 3, further comprising:
a partial executor configured to execute processing of reading the second direction partial data identification index in the matrix data with respect to a command to read data in the conversion target program, and acquiring information indicating the second direction partial data identification index in each of a plurality of pieces of matrix data to be subjected to the first processing.

8. A program conversion method comprising,
by a computer:
detecting matrix data including partial data in a second direction used for determining whether to delete individual pieces of partial data in a first direction in second processing among a plurality of pieces of matrix data, for a conversion target program for performing the second processing of deleting partial data in the first direction, with respect to one piece of matrix data obtained in first processing after performing the first processing of converting a plurality of pieces of matrix data into one piece of matrix data and reassigning a first direction partial data identification index for identifying partial data in the first direction in the converted matrix data;
determining whether both a first condition that processing depending on the first direction partial data identification index is not included in the conversion target program or that a result of processing depending on the first direction partial data identification index is same between the conversion target program and post-conversion program converted to perform the first processing after performing the second processing on the matrix data detected from the conversion target program, and a second condition that the first direction partial data identification index indicated in an execution result of the conversion target program and the first direction partial data identification index indicated in an execution result of the post-conversion program are same, are satisfied; and
converting the conversion target program into the post-conversion program under a necessary condition that it is determined that both the first condition and the second condition are satisfied.

9. A tangible and non-transitory recording medium recording a program causing
a computer to perform:
detecting matrix data including partial data in a second direction used for determining whether to delete individual pieces of partial data in a first direction in second processing among a plurality of pieces of matrix data, for a conversion target program for performing the second processing of deleting partial data in the first direction, with respect to one piece of matrix data obtained in first processing after performing the first processing of converting a plurality of pieces of matrix data into one piece of matrix data and reassigning a first direction partial data identification index for identifying partial data in the first direction in the converted matrix data;
determining whether both a first condition that processing depending on the first direction partial data identification index is not included in the conversion target program or that a result of processing depending on the first direction partial data identification index is same between the conversion target program and post-conversion program converted to perform the first processing after performing the second processing on the matrix data detected from the conversion target program, and a second condition that the first direction partial data identification index indicated in an execution result of the conversion target program and the first direction partial data identification index indicated in an execution result of the post-conversion program are same, are satisfied; and
converting the conversion target program into the post-conversion program under a necessary condition that it is determined that both the first condition and the second condition are satisfied.
